(19) United States
(12) Patent Application Publication
(10) Pub. No.: US 2025/0322121 A1
(43) Pub. Date: Oct. 16, 2025

(54) ELECTRICAL GRID CONNECTION SIMULATION AND REPORTING FOR DISTRIBUTED GENERATORS

(71) Applicant: Renewable Energy Revolution Pty Ltd., OLD BAR NSW (AU)

(72) Inventor: Christopher Rowe, Petaluma, CA (US)

(21) Appl. No.: 18/916,187

(22) Filed: Oct. 15, 2024

Related U.S. Application Data
(60) Provisional application No. 63/633,345, filed on Apr. 12, 2024.

(51) Int. Cl. G06F 30/27; G06F 113/04

(52) U.S. Cl. CPC G06F 30/27; G06F 30/18; G06F 2113/04; G06F 2119/02; G06F 2119/06; H02J 3/00; H02J 2203/20

(57) ABSTRACT

Techniques of distributed generator simulation, analysis, and report generation can include utilizing a core system in which data is managed for the end user automatically. Techniques can include scheduling and allocation of tasks to computers, and providing a simple plain text front-end interface to a user. This can allow a user to perform complex simulations, allocate to optimal computing resources, queue simulation tasks, annotate images, log non-compliance, and/or compile the report. Full reporting can be provided in multiple formats to allow a quick repeat of full studies with simulation changes. The process may be controlled by a human or an artificial intelligence, and task priority may be sorted between multiple engineers while easy changes in system snapshots may be made to use as a basis for system studies, or grid connection studies.

### RELATED APPLICATIONS

This application claims the benefit of U.S. Provisional Application No. 63/633,345, filed Apr. 12, 2024, entitled “ELECTRICAL GRID CONNECTION SIMULATION AND REPORTING FOR DISTRIBUTED GENERATORS”, which is assigned to the assignee hereof, and incorporated herein in its entirety by reference.

### BACKGROUND

Distributed Generation systems are becoming the normal mode of power generation for the electric grid. These distributed generators require simulation and testing to ensure they are not a risk to the greater power grid before connection. Distributed generators include wind farms, solar farms, grid scale batteries, ramping gas turbines and other generation systems. These distributed generators must meet grid codes. Grid codes are specific to the geographic region in which the distributed generator is built. As the penetration of renewable generation increases, grid codes and local requirements need to be updated resulting in rapidly changing reporting requirements. For the connection of each distributed generator reports must be submitted to system operators and power utilities. The reports required to be submitted are generally known as grid connection studies, grid connection reports and model testing reports.

### BRIEF SUMMARY

Techniques of distributed generator simulation, analysis, and report generation can include utilizing a core system in which data is managed for the end user automatically. Techniques can include scheduling and allocation of tasks to computers, and providing a simple plain text front-end interface to a user. This can allow a user to perform complex simulations, allocate to optimal computing resources, queue simulation tasks, annotate images, log non-compliance, and/or compile the report. Full reporting can be provided in multiple formats to allow a quick repeat of full studies with simulation changes. The process may be controlled by a human or an artificial intelligence, and task priority may be sorted between multiple engineers while easy changes in system snapshots may be made to use as a basis for system studies.

An example method of electrical grid connection simulation and reporting for distributed generators, according to this disclosure, may be performed by one or more computers. The method comprises receiving, via one or more online portals, generator model input information, the generator model input information comprising: an instruction file including instructions for simulating and reporting a grid connection model, a power system description file including a description of how components of an electrical power generator model or electrical system model are connected, and one or more component files, wherein each of the one or more component files includes a description of behavior of a respective component of the electrical power generator model or electrical system model. The method further comprises placing the generator model input information in a pipeline for model simulation, and sending the generator model input information to one or more simulators for simulating the electrical power generator model, wherein: sending the generator model input information is performed in an order of model simulation established by the pipeline for model simulation, the generator model input information is sent to the one or more simulators based at least in part on available computing resources of the one or more simulators, and the generator model input information is accompanied by instructions indicative of how the one or more simulators are to perform a set of one or more simulations using the generator model input information, the instructions based at least in part on the instruction file. The method further comprises obtaining a simulation output of the set of one or more simulations, the simulation output comprising: one or more tabulated data files of simulation data, and data file compliance requirements indicative of compliance requirements for each of the one or more tabulated data files. The method further comprises obtaining a compliance output based at least in part on an analysis of the simulation output and in accordance with the instruction file, wherein the compliance output comprises: one or more augmented data files, the one or more augmented data files comprising the one or more tabulated data files and corresponding non-compliance data, a non-compliance log indicative of the non-compliance data, and one or more calculated datasets indicative of calculations performed in the analysis of the simulation output. The method further comprises outputting a simulation report based at least in part on the compliance output and in accordance with the instruction file.

An example system for performing electrical grid connection simulation and reporting for distributed generators, according to this disclosure, comprises: one or more computers, wherein each of the one or more computers respectively comprise one or more communication interfaces, one or more memories, and one or more processors communicatively coupled with the one or more communication interfaces and the one or more memories. The one or more computers are configured to: receive, via one or more online portals, generator model input information, the generator model input information comprising: an instruction file including instructions for simulating and reporting a grid connection model, a power system description file including a description of how components of an electrical power generator model or electrical system model are connected, and one or more component files, wherein each of the one or more component files includes a description of behavior of a respective component of the electrical power generator model or electrical system model. The one or more computers are further configured to place the generator model input information in a pipeline for model simulation, and send the generator model input information to one or more simulators for simulating the electrical power generator model, wherein: sending the generator model input information is performed in an order of model simulation established by the pipeline for model simulation, the generator model input information is sent to the one or more simulators based at least in part on available computing resources of the one or more simulators, and the generator model input information is accompanied by instructions indicative of how the one or more simulators are to perform a set of one or more simulations using the generator model input information, the instructions based at least in part on the instruction file. The one or more computers are further configured to obtain a simulation output of the set of one or more simulations, the simulation output comprising: one or more tabulated data files of simulation data, and data file compliance requirements indicative of compliance requirements for each of the one or more tabulated data files. The one or more computers are further configured to obtain a compliance output based at least in part on an analysis of the simulation output and in accordance with the instruction file, wherein the compliance output comprises: one or more augmented data files, the one or more augmented data files comprising the one or more tabulated data files and corresponding non-compliance data, a non-compliance log indicative of the non-compliance data, and one or more calculated datasets indicative of calculations performed in the analysis of the simulation output. The one or more computers are further configured to output a simulation report based at least in part on the compliance output and in accordance with the instruction file. Aspects may further include one or more of the following features. A system of computer(s); receiving generator models and system models, performing simulations and producing automated generator connection study reports. A system of computer(s); receiving generator models and system models, performing simulations and producing automated generator connection study reports including annotation of non-compliances with grid codes. A system of computer(s); performing grid connection studies driven by a plain text file known as a Ribbon Grid file. The Ribbon Grid file describes how to compile and run the entire grid connection in plain text. A Ribbon Grid plain text language and an interpreter for the language. A document generation system that includes an electronic datestamp/signature module able to verify the completion of grid connection studies by computers. A document generation system that includes a verified report output detailing the files and computers used to complete the grid connection studies. A document generation system that includes a verified package creation module able to output verified reports packaged with the files that were the verified inputs of the grid connection studies. A script management portal that allows users to control the exact linkage of scripts with Ribbon Grid file plain text directives. A system that compiles complete HTML reports which include all data points of all simulations performed within the grid connection study, allowing a user to view every data point. A system including a deep learning oversight module that employs artificial intelligence to automatically make decisions of whether to rerun simulations or to not rerun simulations or to alter settings of the generators to gain compliance with relevant grid codes. A compliance analysis and artificial intelligence module that identifies non-compliant data and tags the data such that it produces a visualization on the grid connection studies reporting and/or a log script record.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a block diagram of an example embodiment of a system capable of performing the functions described herein, according to an embodiment.

FIG. 2 is a block diagram of an example of the document generation system of FIG. 1.

FIG. 3 is a block diagram of an example of the script management portal for FIG. 1.

FIG. 4 is a block diagram of an example hardware topology capable of performing the functions described herein.

FIG. 5 is a block diagram of an example computer, including hardware and software components, which may be used to perform at least some of the functions described herein, according to an embodiment.

FIG. 6 is a flow diagram of an example method of how automated reports may be produced (e.g., by a system of one or more computers), according to some embodiments.

FIG. 7 is a flow diagram of an example method of how automated reports may be produced (e.g., by a system of one or more computers), according to some embodiments.

FIG. 8 is a flow diagram of an example method of how the automated reports may be produced (e.g., by a system of one or more computers), according to some embodiments.

FIG. 9 is a flow diagram of an example method of how the automated reports may be produced (e.g., by a system of one or more computers), according to some embodiments.

FIG. 10 is a flow diagram of flow diagram of a method of electrical grid connection simulation and reporting for distributed generators, according to some embodiments.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

With respect to distributed generators, traditional methods of simulation, analysis, and report writing are labor-intensive. Traditional methods require large amounts of engineering time to complete. Traditional approaches can fail to identify problems, due to human error and lack of advanced knowledge. The cost of grid connection studies creates a financial burden on the construction of renewable energy and distributed generation systems. Many engineers do not have the skills or experience to correctly choose inverter settings. The use of incorrect inverter settings puts the grid at risk of blackouts. Limited specialized experts choose inverter settings and correctly analyze the risks of new generation by viewing simulation results. Engineering companies use traditional tools of standard power systems simulators, the results are saved in tabular data, the results are manually interpreted, results are graphed, or figures are exported from the traditional power system simulation tool and reports are written by hand.

The core system 100 described here improves the current state of the art in many parallel and interrelated ways. Data is managed by the data collection engine 115 for the end user automatically between computers 470. Scheduling and allocation of tasks to computers 470 is handled by the scheduler and allocation module 105. A simple plain text front end interface is provided to the user. The user needs no coding experience to develop plain text Ribbon Grid directives to instruct the core system 100 how to: perform complex simulations, allocate to optimal computing resources, queue simulation tasks, annotate images, log non-compliance and compile the report. Full reporting is automated in multiple formats by the document generation system 130, this allows a quick repeat of full studies if one inverter control setting changes or another element changes. This minimizes the risk of time overruns in engineering hours. Due to the plain text interface, the core system lends itself to automation by artificial intelligence with recent innovations in large language models. The system is designed to be controlled by either a human or an artificial intelligence with the Ribbon Grid file as the plain text interface innovation making this possible. The system shifts work from engineers to automation and artificial intelligence. The generator model pipeline 150 allows for sorting of task priority between multiple engineers while the system model pipeline 140 allows easy changes in system snapshots to use as a basis for system studies.

### Core System

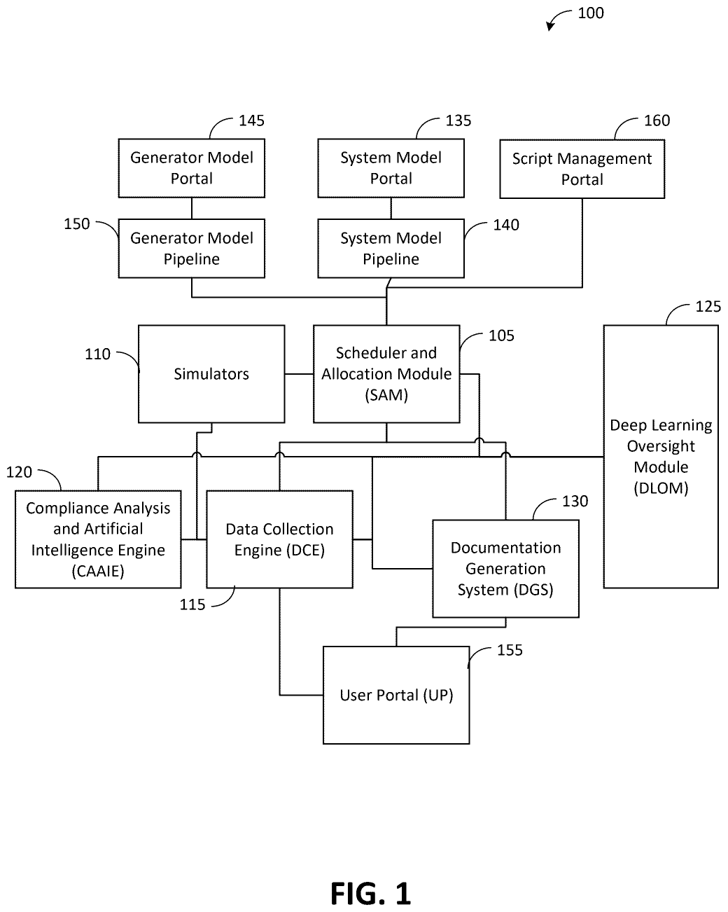

FIG. 1 is a block diagram of an example embodiment of a core system 100, according to an embodiment. As with other figures described herein, FIG. 1 is provided as a non-limiting example. Alternative embodiments may combine, separate, and/or rearrange the various modules shown and described herein to provide similar functionality.

The core system 100 may include a variety of modules, including the scheduler and allocation module (SAM) 105, the Simulators 110, the data collection engine (DCE) 115, the compliance analysis and artificial intelligence engine (CAAIE) 120, the deep learning oversight module (DLOM) 125, the document generation system (DGS) 130 and the user portal (UP) 155.

The core system 100 may be implemented using one or more computer(s) that can execute the functionality of the modules illustrated in FIG. 1 to perform grid connection studies and/or model quality tests driven by a plain text file known as a Ribbon Grid file (RG file). The Ribbon Grid file describes how to run the grid connection studies and compile reporting in plain text. The core system 100 is configured by one Ribbon Grid file per project or reporting task.

According to embodiments, the Ribbon Grid file is an innovative aspect of this new method and apparatus. The Ribbon Grid file describes how to compile and run the entire grid connection study in plain text. An example of a Ribbon Grid file:
- - - Ribbon Grid File for XYZ Solar Farm (comment) - - -
START USER
run PSSe
run PSCAD
include SMIB STUDIES
region CA_ISO
run all_compliance
output all_reports
output verified_package
END USER

In this example, the core system 100 may run all of the required tests for California ISO grid connection studies compliance. It may run these in both PSSe and PSCAD and overlay the results as required by the run all_compliance command. It may only run Single Machine Infinite Bus (SMIB) studies with these directives, not including system studies. It may then produce both PDF and HTML reports and a verified package. The verified package may include all the model and system input files with the generated reports including a verified time date stamped page within a zip the package. All of this may be completed with minimal human intervention. Additional details regarding various aspects of a Ribbon Grid file, according to some embodiments, are provided below.

The core system 100 digests the Ribbon Grid file and this dictates how the simulations interact with the compliance analysis and artificial intelligence engine (CAAIE) 120 which can be used to select the parameters and settings of the distributed generator model for better grid code compliance. According to some embodiments, there may be a mechanism in the core system 100 to achieve a change in settings of the distributed generator, i.e. the change of model settings that correspond to alteration of the generator's Power Plant Controller settings and inverter settings. This system is intended to assist engineers who do not have the expertise to select the best settings for a certain region of compliance. Generally, this may be referred to as “AI based auto-tuning of distributed generator settings”. In some embodiments, the CAAIE 120 may have constant access to the data within the DCE 115.

The CAAIE 120 may comprise two modules (not shown), a compliance analysis module and an artificial intelligence module. The compliance analysis module uses direct comparison to requirements, for example: greater than limit, less than limit, voltage may not exceed 1.1 per unit etc. The artificial intelligence module also constantly scans the output data to determine if there are deleterious behaviors by running complex algorithms. For example, it may detect oscillations in power or current that are hard to detect with linear mathematics. The compliance analysis and artificial intelligence modules identify non-compliant data and tag the data such that it produces a visualization on the grid connection studies reporting and/or a log script record.

In some embodiments of the system, the compliance analysis visualization on reporting maybe disabled. In some embodiments of the system the CAAIE 120 and the DLOM 125 are disabled or not used.

The SAM 105 assigns tasks to the Simulators 110 and the Document Generation System (DGS) 130. The tasks describe to the Simulators 110 the exact detail of what simulations to run, what simulation software to utilize and what computers (CPU, GPU requirements etc.) to use. The tasks to the DGS 130 describe how to plot simulation data and how to compile the reporting.

In some embodiments, the Simulators 110 of the core system 100 are based on simulation software of PSSe, PSCAD, Digsilent, EMTP, MATLAB, Simulink, ETAP, OpenDSS, CYME and NREL ParaEMT. In some embodiments of this system, the Simulators 110 of the core system 100 may be based on other Electro Magnetic Transient modeling software or other power flow solver software.

In some embodiments of the system, the simulations run on quantum computers with quantum power system solvers.

In some embodiments of the system, the simulations run on machines hosted by other companies, for example, PSSe cloud by Siemens. In some embodiments, the scheduler may be disabled and the user may perform the scheduling of specific simulation tasks manually with a user interface that directly controls the SAM 105. In some embodiments of this system, the SAM 105 while driven manually may be represented by a graphical interface with blocks representing certain tasks.

In some embodiments of the system, SAM 105 is hosted in the cloud by a cloud services provider (AMAZON WEB SERVICES etc.).

Note that, in some embodiments, the SAM 105 may also have the responsibility to alter the settings of models. This may be pre-configured as a conditional multiple task loop, i.e. looping through an array of settings, increasing or decreasing settings to search for compliance, etc. In the machine learning embodiment, settings may be requested directly by the DLOM 125. The requested setting changes may be implemented before it schedules subsequent runs of simulations.

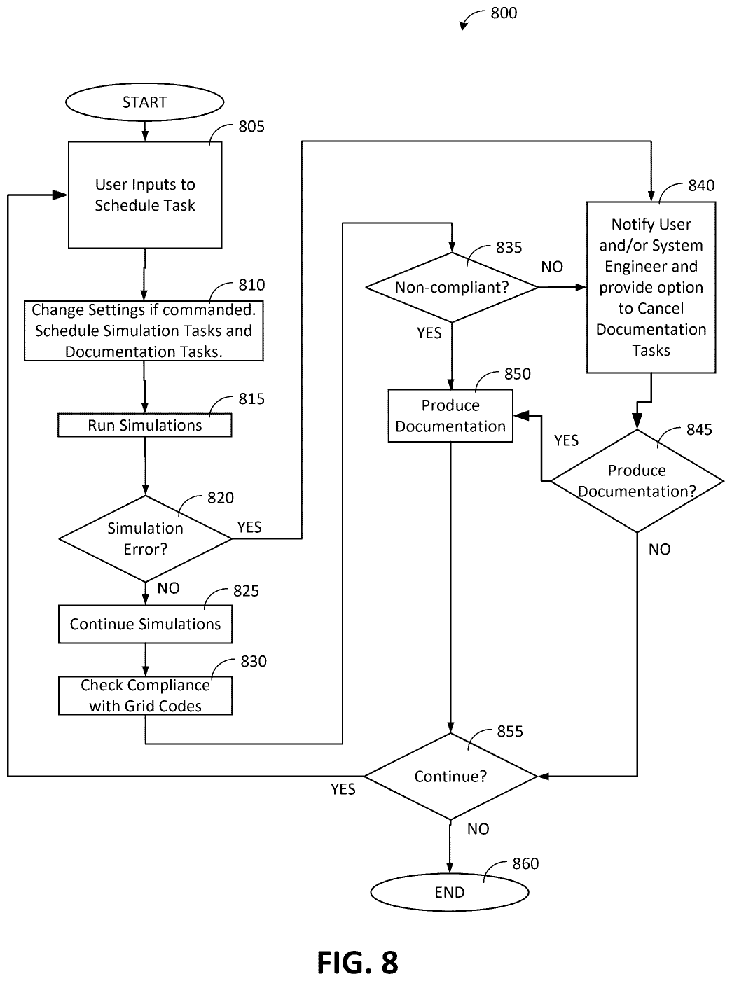

In some embodiments, the Ribbon Grid file may be omitted from the process. Such embodiments may, for example, use the method shown in FIG. 8, which is discussed in more detail below.

In some embodiments, a cloud-based messaging broker system may be used to transfer the Ribbon Grid file to multiple computers, to synchronize and coordinate the transfer of data within the local intranet or on the world wide web, to the DCE 115. In some embodiments, the DCE 115 includes a file transfer handler that manages the computer to computer (peer to peer) file transfers via TCP, UDP, HTTPS etc. The file transfers may use compression to decrease transfer time duration.

In some embodiments, file transfers may be completed computer to computer (peer to peer) using a transfer protocol that guarantees the data stays inside the local intranet or virtual private network (VPN). In some embodiments, the data may be transferred to a cloud server and back down to the other computer.

In some embodiments, the plot data is stored a cloud application to allow cloud web viewing of the data when working remotely. In some embodiments, the data may be transferred by the DCE 115, to the users laptop computer data endpoint at completion of the project, such that the user can view the project locally.

In some embodiments of the DCE 115, it may archive project data once a project is completed.

### Setting Selection and System Automation by Artificial Intelligence

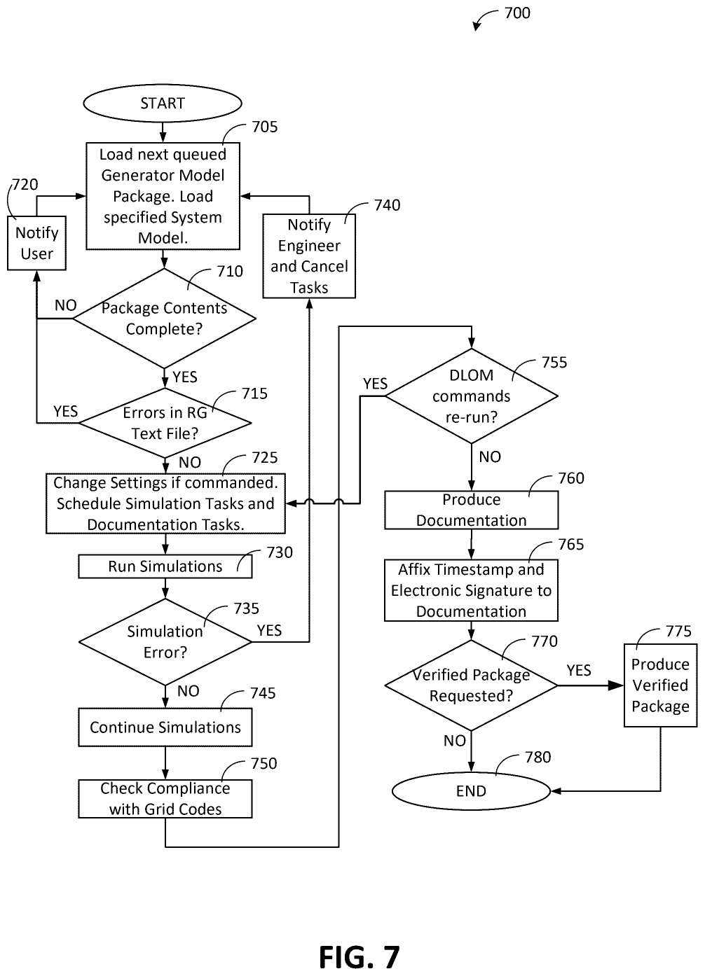

The DLOM 125 in some embodiments may make the decisions of: whether to rerun the tests, or to not rerun the tests, or to change the generator settings based on all of the learning it has gained over its entire lifetime. To enable this functionality, the DLOM 125 may execute the method in FIG. 7, where re-run decisions are based on the deep learning guidance. Method 7 is discussed in more detail below.

According to some embodiments, the DLOM 125 retains knowledge throughout all studies of many different projects and many different runs; it is an element of this system that has persistent memory. In some embodiments of the core system 100, the simulations may be rerun multiple times to determine the optimal settings. In other embodiments, the test may only be rerun if there is a non-compliance detected.

In some cases, the usage of the term artificial intelligence may include machine learning, neural networks or deep learning. In some cases, the usage of the term deep learning may include artificial intelligence, neural networks or machine learning.

### Data Input Pathways

The system model portal 135 (communicatively) connects to the system model pipeline 140, which connects into the SAM 105. This input pathway is described in more detail below. There is a second parallel input path, beginning with the generator model portal 145 which connects into the generator model pipeline 150, which also connects to the SAM 105.

The core system 100 has a User Portal (UP) 155 and script management portal 160 that allows users to manipulate the scripts, script linkage and script usage in detail.

In some embodiments the generator model portal 145 provides a web-based front end where users can configure the generator network and settings. In other embodiments the generator model portal additionally or alternatively may comprise an API or a local program that allows the users to queue projects in a desired order. In some embodiments of the core system 100, the system model portal 135 and system model pipeline 140 are not used, for example in Single Machine Infinite Bus (SMIB) or other simulations that do not require a connection of an individual generator model to a larger system. It is expected that the normal use case of the system model pipeline 140 would be for system operators and utilities to regularly upload systems with recent generation added, for example they may release to the pipeline a new electrical network file every week.

In some embodiments the generator model portal 145 may allow the entry of pointers to local intranet locations and folders. The system may use the pointers to retrieve the input data files.

In some embodiments of the core system 100, an engineer may need to review the input models for compatibility with the core system 100 and the Ribbon Grid file. The human review may occur in the: system model portal 135, system model pipeline 140, generator model portal 145, generator model pipeline 150, the SAM 105, or any combination thereof. In some embodiments, the input pipelines may be eliminated, and the portals all combined into one portal.

In some embodiments of the system, an engineer or user may access the script management portal 160 to alter the linkage between Ribbon Grid plain text directives and underlying code to be executed (RG files, Python code files etc.).

In some embodiments, the script management portal 160 may be combined with, or contained in, the UP 155.

In some embodiments of the system, an engineer or user may access the script management portal 160 to include custom code snippets, custom code from a company library or custom code from a local library or collection of files.

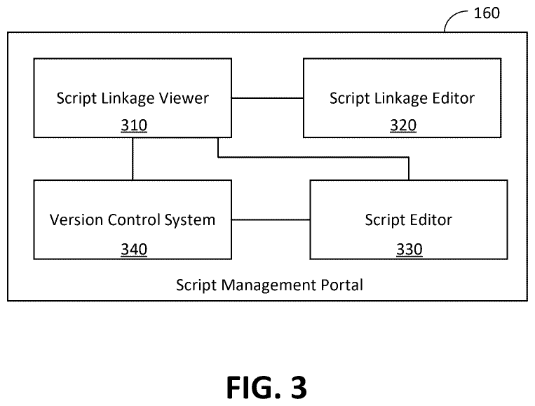

In some embodiments of the system, an engineer or user may access a version control system 340 (shown in FIG. 3) inside the script management portal 160 to view the changes between the last saved Ribbon Grid file and the current edited Ribbon Grid file, or to view the changes between the last saved linked script (RG files, Python code files etc.) and the current edited linked script, or any past script etc. This viewing of the file changes is commonly known as a ‘diff’ view.

In some embodiments, the UP 155 or script management portal 160 may include a viewer with change sets (diff's) to see what has changed in the entirety of the important project settings. That is, provide a text based view of an internal inspection of model settings.

In some embodiments, the distributed generator manufacturer, i.e., solar inverter manufacturers or wind turbine manufacturers etc., may have their own portal to upload their latest models into the system.

The script management portal 160 may include version control on each file allowing the user to roll back to any number of previous file versions, to branch or merge files.

In some embodiments, the UP 155 may allow the input of hardware test data and site data into the core system 100 to overlay the hardware or site data and simulation results. For example, the overlay of type test data from inverter lab testing with type test simulations of EMT and phasor domain models; or the overlay of post commissioning site data to prove model compliance with the EMT and phasor models domain of commissioned wind farm.

In some cases, the version control system 340 links to a web hosted common version control system such as GitHub, BitBucket, etc.

### Data and Reporting Output Pathways

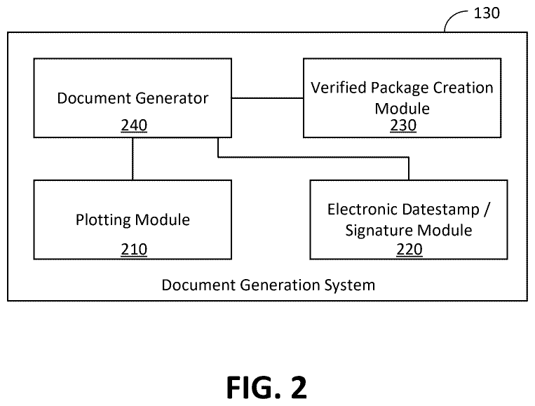

The internals of the DGS 130 are shown in FIG. 2, described below. The DCE 115 collects all the relevant data for the core system 100 for the relevant reporting to be generated. The DCE 115 is connected to the DGS 130, as shown in FIG. 1. The DGS 130 also may be connected to the UP 155, Simulators 110 and SAM 105, as shown in FIG. 1.

FIG. 2 is a diagram of a DGS 130, according to an embodiment. According to some embodiments, the DGS 130 may produce: PDF documents, HTML documents, and may include ‘Plotly’ (or similar) plots or ‘Plotly Dash’ apps that allow all data to be visualized by the user. In some embodiments of the software the DGS 130 may produce additional or alternative output file formats, for example doc and docx extensions. In some embodiments of the software, the HTML files use a different basis other than Plotly to create HTML two-dimensional and three-dimensional plots that include all simulation data points and have integral interactive zoom.

In some embodiments of the DGS 130, the results from two or more different simulation engines will be overlaid on one graph. For example, both data from PSSe and PSCAD may be overlaid on one graph. Limits, analysis and compliance requirements may be visualized on the same graph.

The DGS 130 may produce a number of different reports based on the geographic region of the distributed generator to be connected to the power grid. An example of a document generator 240 is shown in FIG. 2. Reports generated may include: Model Acceptance Tests (MAT), Model Quality Tests (MQT), Dynamic Model Acceptance Tests (DMAT), Generator Performance Standard (GPS) documentation, a grid connection study, a study of relevant powerline dynamic fault analysis for the generator interconnection point, a system impact analysis for the addition of the generator, a static PQ capability and analysis report, and/or a complete dynamic analysis report for power system simulation (electromagnetic transient, power flow solver based, etc.).

The DGS 130 and document generator 240 may produce a number of different reports based on the System Operator of the region where the distributed generator is to be connected to the power grid. These may include: California ISO (CAISO) generator grid connection study report (whole or a fractional part of), New York ISO (NYISO) generator grid connection study report (whole or a fractional part of), Electric Reliability Council of Texas (ERCOT) generator grid connection study report (whole or a fractional part of), Midcontinent Independent System Operator (MISO) generator grid connection study report (whole or a fractional part of), New England Independent System Operator (NE-ISO) generator grid connection study report (whole or a fractional part of), Southwest Power Pool (SPP) generator grid connection study report (whole or a fractional part of), Pennsylvania-New Jersey-Maryland Interconnection (PJM) generator grid connection study report (whole or a fractional part of), Alberta Electric System Operator (AESO) generator grid connection study report (whole or a fractional part of), Independent Electricity System Operator (IESO) generator grid connection study report (whole or a fractional part of), and/or the Australian Energy Market Operator (AEMO) generator grid connection study report.

The grid connection study reports may include Model Acceptance Tests (MAT) and/or Model Quality Tests (MQT).

The DGS 130 may include a plotting module 210 which has several features including: production of plots in image format, that is: gif, jpeg, png etc.; production of full data plots with interactive zoom in HTML (for example, ‘Plotly’ plots and ‘Plotly Dash’ apps) and other web formats; annotation, extraction and tabulation of voltage, power, current and other variables; rise and settling times; annotation, extraction and tabulation of voltage, power, current and other variables step change magnitudes; and the alignment of steps in voltage and other graphs based on duplicate simulations, or analysis of the data by advanced algorithms to correctly align the plots, for example: aligning PSSe and PSCAD plots for a 5% voltage step change and overlaying all plots of voltage, power, current and other variables together on one or multiple linked plots, i.e. having a shared time axis.

The DGS 130 may include a electronic datestamp/signature module 220 that produces a digital fingerprint or verified report front page. In some embodiments of the system the digital signature is created by a third party system or web application.

The DGS 130 may include an option to create a verified package, via a verified package creation module 230. The verified package may combine the input data files and model files with verified reports. In some embodiments, the verified package is a password protected compressed file for example a zip file.

Additional details regarding the plotting module 210, electronic datestamp/signature module 220, and verified package creation module 230, as well as details regarding the document generator 240, are provided below.

In some embodiments of the core system 100, the UP 155 allows the user to view results generated by the DGS 130 on a web-based interface. In some embodiments of the core system 100, the UP 155 can automatically e-mail the results to a desired e-mail address. In some embodiments of the core system 100, the UP 155 allows download of the output data files (e.g., including those generated by the DGS 130).

In some embodiments, the report generation may include an option to only repeat the studies and reports for only one section of the report, not the whole report, to save computational time.

FIG. 3 is a block diagram of a script management portal 160, according to some embodiments. A detailed description of the script management portal 160 and each of the sub blocks illustrated in FIG. 3 is provided below.

### Hardware System

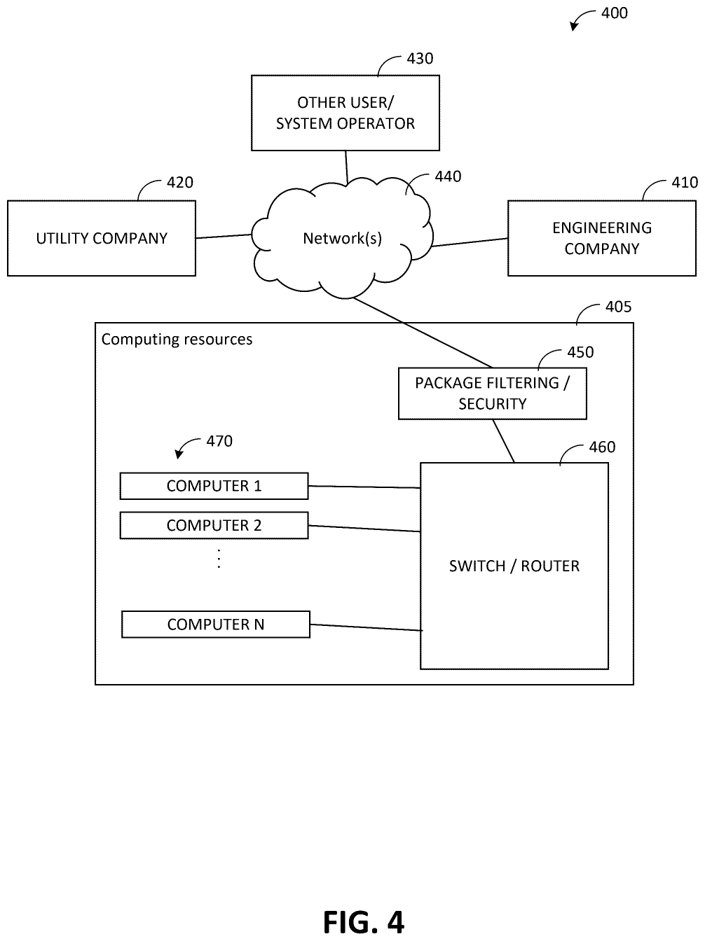

FIG. 4 is a diagram of a physical system 400, according to an embodiment. Put generally, the functionality of the core system 100 described herein may be executed by computing resources 405. Computing resources 405 may generally include any type of cloud or local computing resources, which may be provided by one or more cloud computing services, a service provider of the core system 100 described herein, one or more customers thereof, or the like. The data provided to the core system 100 (and thus, the computing resources 405) may be provided by an engineering company 410, a utility company 420, and/or other user or system operator 430. Moreover, the data may be provided via one or more networks 440, which may include one or more public and/or private communication networks (e.g., and intranet and/or the Internet). General aspects of a physical system capable of implementing some or all functions of the core system 100 are depicted in FIG. 4. As illustrated, the input data passes through a package filtering and security layer 450, and through a switch or router 460 to one or more computers 470.

It will be understood that the architecture illustrated in FIG. 4 is provided as a simplified example. In practice, a physical system 400 may include additional or alternative components and/or other variations that are not illustrated in FIG. 4. In view of FIG. 4 in the description herein, a person of ordinary skill in the art will appreciate such variations.

The location of the computing resources 405 can vary, depending on desired functionality. Put broadly, computing resources 405 may be located at a single geographical location, or at multiple geographical locations, depending on desired functionality. In some embodiments, some or all of the computing resources 405 may be located at the premises of the utility company 420, other user/system operator 430, and/or engineering company 410. In some embodiments, the computing resources 405 may be implemented on a rack of physical servers. In some embodiments, instead (or in addition to) a rack of physical servers, the computer(s) 470 may comprise an interconnected network of computers (e.g., on a company intranet). In such embodiments, the intranet and interconnected computers may span multiple office locations. In some embodiments, computing resources 405 may include a plurality of server racks. In some embodiments, computing resources 405 may include a plurality of package filtering or security devices. In some embodiments, computing resources 405 may include a plurality of switches and routers 460.

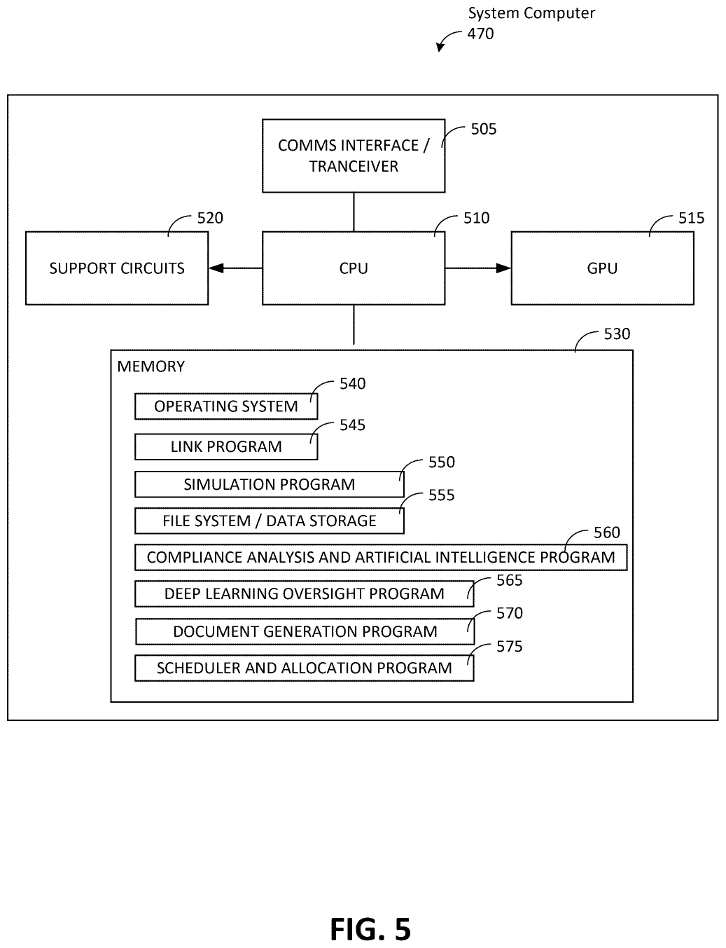

It can be noted that the number, N, of computers 470 may include any number of one or more computers. The computer(s) 470 within the computing resources 405 may contain one or more software programs that run on the memory of a respective computer 470. An example of a generalized computer in the system of computers is depicted in FIG. 5.

FIG. 5 is a diagram of an example of a generalized computer 470, according to an embodiment. A person of ordinary skill in the art will appreciate that various types of computer architectures may be used to implement a computer 470 as described herein. The computer 470 of FIG. 5 may correspond with any or all of the computers 470 illustrated in FIG. 4. The computer 470 comprises a communications interface/transceiver 505 connected to a central processing unit (CPU) 510. The CPU 510 is connected to a graphics processing unit (GPU) 515 and to support circuits 520. The CPU 510 is connected to the computer memory 530.

The computer memory 530 may comprise storage (e.g., hard drives/disk drives, such as magnetic, optical, flash, etc.) as well as volatile memory (e.g., random-access memory (RAM) and nonvolatile memory (e.g., read-only memory (ROM)). The various components in FIG. 5 within memory 530 may comprise various software and/or firmware programs stored in the memory 530 an executed by the CPU 510, GPU 515, support circuits 520, or any combination thereof. This can include the operating system 540 of the computer 470 and a link program 545 that links multiple computer systems together. The memory 530 may further include one or more simulation programs 550, for example: PSSe, PSCAD, Digsilent, EMTP, MATLAB, Simulink, ETAP, OpenDSS, CYME, NREL ParaEMT, other Electro Magnetic Transient modeling software or other power flow solver software. In some cases, there will be a plurality of simulation programs installed on one computer. The computer memory may further include a file system for data storage 555. In some embodiments of the structure the data of the file system 555 is stored on the cloud, for example, on AMAZON WEB SERVICES or GOOGLE CLOUD PLATFORM.

The compliance analysis and artificial analysis program 560 runs on the computer memory and implements the functionality of the CAAIE 120 block of FIG. 1.

The deep learning oversight program 565 runs on the computer memory and implements the functionality of the DLOM 125 block of FIG. 1.

The document generation program 570 runs on the computer memory and implements the functionality of the DGS 130 block of FIG. 1.

The scheduler and allocation program 575 runs on the computer memory and implements the functionality of the SAM 105 block of FIG. 1.

On the computer memory also runs the modules as described in the core system 100 of FIG. 1.

In some cases, the computer will run only a subset of one or more of the programs 540-575 of the memory 530 illustrated in FIG. 5, not all of them. This may depend on the particular functionality of the core system 100 executed by the computer 470. For example, a computer 470 executing the functionality of the simulators 110 may only run the link program 545 and one or more simulation programs 550. Another example, a computer 470 executing the functionality of the SAM 105 may only run the link program 545 and scheduler and allocation program 575, etc.

In a system of computers (e.g., computers 470 of computing resources 405 of FIG. 4), different computers 470 may run different programs such that, collectively, the system runs more programs than any single computer in the system. Load-balancing and/or other functions may be performed to help ensure a system of computers operate sufficiently to execute the various functions of the core system 100.

In some cases, the link program 545 runs on computer(s) 470 that have simulation engines installed on them. The link program packetizes data and connects it to the network of the system of computers. The link program has a configuration interface allowing an information technology (IT) professionals to configure the details of installed programs or automatic configuration that detects the installed programs.

### Methods

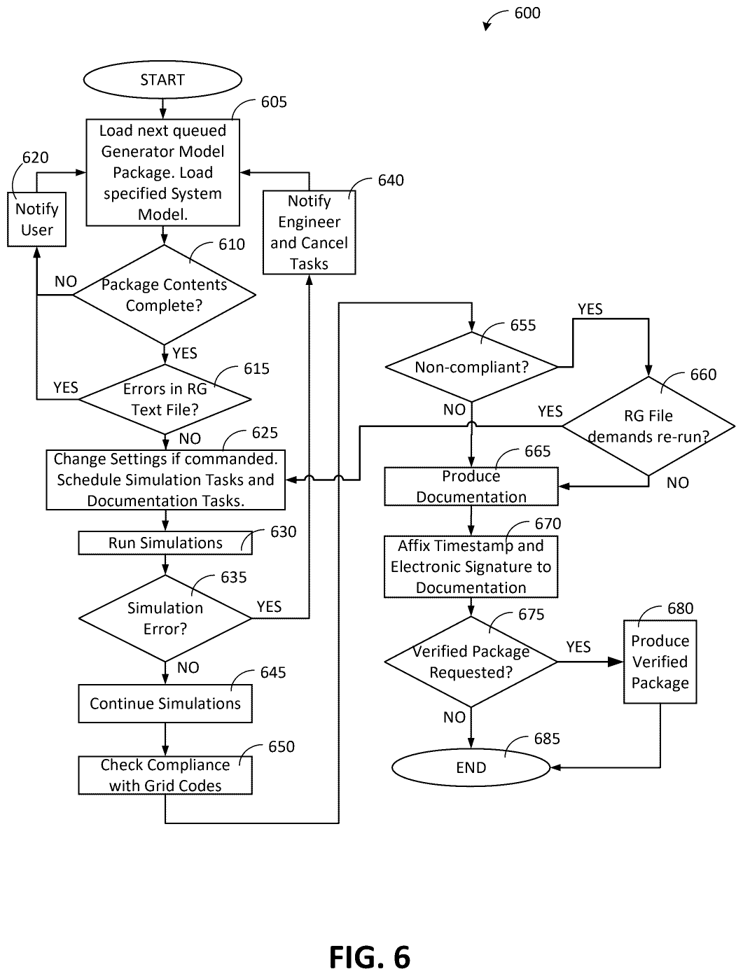

The core method that describes an innovative aspect, correlated to the core system 100, is shown in FIG. 6. This is the core method for automated grid connection study data and report generation.

The complete method including the DLOM 125 is shown in FIG. 7. This is a method for a deep learning based system where re-run decisions are based on the deep learning guidance.

A user scheduled method, without a Ribbon Grid file, is shown in FIG. 8. This method is a user scheduled method.

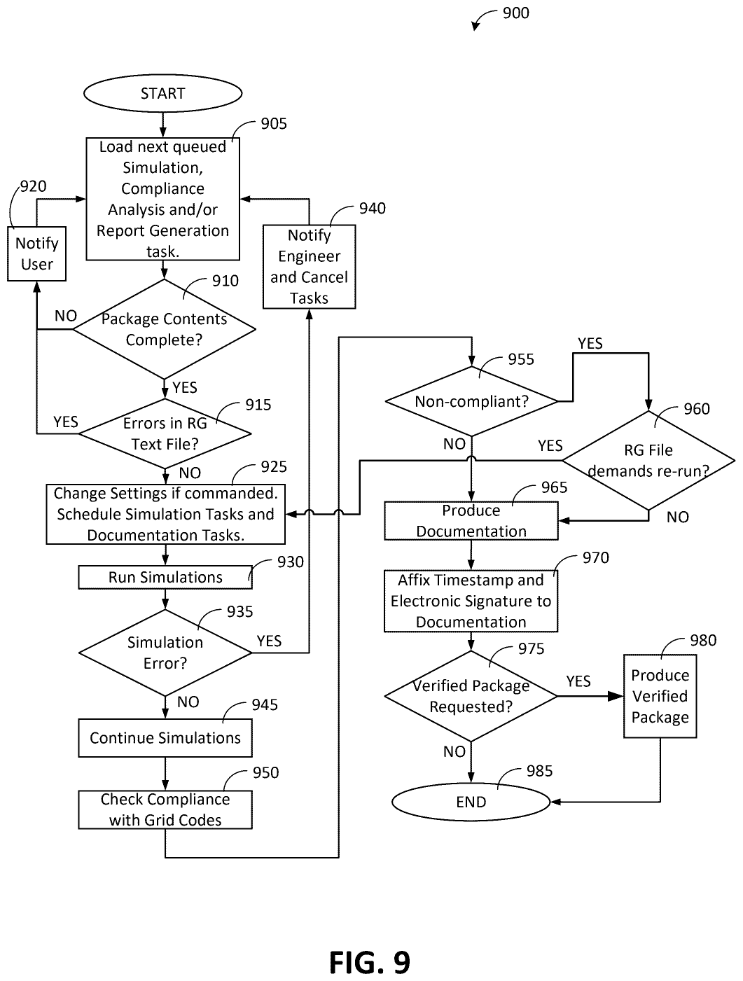

An individual task method is shown in FIG. 9. This individual task method is a variation on the core method in which the user can queue tasks rather than the tasks flowing from the generator model pipeline 150.

FIG. 6-FIG. 9 describe four methods. These four methods detail examples of alternate use cases of the core system 100. The configuration of the behavior of the core system 100 may be set in the SAM 105 and or the UP 155. The configuration of the behavior of the core system 100 may be set in the text in the plain text Ribbon Grid file.

FIG. 6 is a flow chart of a basic method 600 for automated grid connection study data and report generation, according to an embodiment. Some or all of the operations of method 600 may be performed by one or more of the blocks of the core system 100, according to some embodiments. The method may run once or may repeat. The method begins at START. The SAM 105 loads the next system task in block 605, this may include loading a distributed generator model from the generator model pipeline 150 and loading a system model from the system model pipeline 140. A system model may not be used. In block 610, the contents of the data provided are examined, and if the content is not complete, the user is notified 620. In any case where the user is notified 620, the system then returns to 605, to load the next system task. If the package content is complete 610, then the system moves on to check for errors in the Ribbon Grid text file 615, to ensure the directives can be run correctly on the system. If there are errors the system notifies the user 620. If there are no errors, the system progresses to the setting calibration stage 625. In block 625, the system schedules both simulation and documentation tasks (which include plotting tasks as a sub task). If settings changes are commanded, this is also completed in block 625. Block 625 is the junction of rerun tasks, it is the beginning of looped solution operations, within a single system task. In some embodiments, blocks 605, 610, 615, 620 and 625 are completed by the SAM 105. The simulation tasks are allocated to specific computer(s) 470 identified in the Ribbon Grid file directives or system standard operation. Simulation tasks are performed and results obtained in 630, by the simulation program(s) 550. The link program 545 monitors the simulation progress, and if any errors have occurred, this is flagged in block 635. In the case an error has occurred in the simulation(s), the engineer is notified and the system tasks are cancelled 640. The difference of the usage of notify user versus notify engineer in the case of block 620 vs block 640 is that a user is conceptually an end user submitting tasks, whereas an engineer is working on the maintenance of the correct operation of the system. As such notify engineer 640, has a deeper level of inspection and correction available to attempt to solve an issue for all users. Notify user 620 is provided to allow a user to correct their individual inputs, namely the Ribbon Grid file directives or input data. In the case there is no simulation error 635, we continue simulations 645. On completion of simulations, the system checks the compliance 650. Compliance checks 650 may be performed by another computer, for example one running only the link program 545 and the compliance analysis and artificial intelligence program 560. Compliance checks are performed by the CAAIE 120. The compliance analysis and artificial intelligence program 560 checks the compliance in 650 and determines if there are any non-compliances 655. Non-compliances are recorded in 650. If there are any non-compliances, these studies may be rerun. The system checks if the Ribbon Grid file has directives to demand rerun on non-compliance event 660. If there is no rerun directive 660 or the system is compliant in 655, the system produces documentation 665. The document generation program 570 may run on a different computer to the other functions. Once the documentation is produced and a timestamp and an electronic signature is affixed to the report 670, in some embodiments. The documentation tasks are part of the DGS 130. If a verified package has been requested 675, then a verified package is produced 680. Once the verified package has not or has been produced (if requested) the process reaches the END 685.

FIG. 7 is a flow chart of a method 700 performed by a deep learning based system (e.g., using a DLOM 125 or a similar function) where re-run decisions are based on the deep learning guidance, according to an embodiment. The method may run once or may repeat. The method begins at START. The SAM 105 loads the next system task in block 705, this may include loading a distributed generator model from the generator model pipeline 150 and loading a system model from the system model pipeline 140. A system model may not be used. In block 710, the contents of the data provided is examined and if the content is not complete the user is notified in 720. In any case where the user is notified 720, the system then returns to 705, to load the next system task. If the package content is complete 710, then the system moves on to check for errors in the Ribbon Grid text file 715, to ensure the directives can be run correctly on the system. If there are errors the system notifies the user 720. If there are no errors, the system progresses to the setting calibration stage 725. In block 725, the system schedules both simulation and documentation tasks (which include plotting tasks as a sub task). If settings changes are commanded, this is also completed in block 725. Block 725 is the junction of rerun tasks, it is the beginning of looped solution operations, within a single system task. In some embodiments, blocks 705, 710, 715, 720 and 725 are completed by the SAM 105. In this method the block 725 may take directives from the DLOM 125, shown in block 755, on the first, second or any iteration of the loop that begins at block 725 and ends at block 755. In block 730, the simulation tasks are allocated to specific computer(s) 470 identified in the Ribbon Grid file directives or system standard operation. Simulation tasks are performed and results obtained in 730, by the simulation program(s) 550. The link program 545 monitors the simulation progress and if any errors have occurred this is flagged in block 735. In the case an error has occurred in the simulation(s), the engineer is notified and the system tasks are cancelled 740. The difference of the usage of notify user versus notify engineer in the case of block 720 vs block 740 is that a user is conceptually an end user submitting tasks, whereas an engineer is working on the maintenance of the correct operation of the system. As such notify engineer 740, has a deeper level of inspection and correction available to attempt to solve an issue for all users. Notify user 720 is provided to allow a user to correct their individual inputs, namely the Ribbon Grid file directives or input data. In the case there is no simulation error 735, we continue simulations 745. On completion of simulations, the system checks the compliance 750. Compliance checks 750 may be performed by another computer, for example one running only the link program 545 and the compliance analysis and artificial intelligence program 560. Compliance checks are performed by the CAAIE 120. The compliance analysis and artificial intelligence program 560 checks the compliance in 750 and works in parallel with the DLOM 125 to determine if rerun is required 755. Non-compliances are recorded in 750. If the DLOM determines 755, studies are rerun. The compliance analysis and artificial intelligence program 560 and the deep learning oversight program 565 may be in high speed communication during the system operation. As such, the DLOM rerun commands 755 may interrupt the compliance checks 750 at times. Once the DLOM 125 is satisfied with the results in 755, the system progresses and produces documentation 760. The document generation program 570 may run on a different computer to the other functions. Once the documentation is produced and a timestamp and an electronic signature is affixed to the report 765, in some embodiments. The documentation tasks are part of the DGS 130. If a verified package has been requested 770, then a verified package is produced 775. Once the verified package has not or has been produced (if requested) the process reaches the END 780.

FIG. 8 is a flow chart of a user scheduled method 800, according to an embodiment. The method may run once or may repeat. The method begins at START. The SAM 105 loads the next system task in block 805, this may include loading a distributed generator model from the generator model pipeline 150 and loading a system model from the system model pipeline 140. A system model may not be used. This method includes a generic interface. The UP 155 may connect to an application programming interface or system protocol of the users choice. The UP 155 may be configured with blocks, flow diagrams or code languages to provide a human interface. The user inputs the tasks in 805. In block 810, the system schedules both simulation and documentation tasks (which include plotting tasks as a sub task). If settings changes are commanded, this is also completed in block 810. In some embodiments, blocks 805 and 810 are completed by the SAM 105. The simulation tasks are allocated to specific computer(s) 470 identified in the UP 155 or system standard operation. Simulation tasks are performed and results obtained in 815, by the simulation program(s) 550. The link program 545 monitors the simulation progress and if any errors have occurred this is flagged in block 820. In the case an error has occurred in the simulation(s), the engineer is notified and the simulation tasks are cancelled in 840. An option to produce documentation or not is also provided in 840. In the case there is no simulation error 820, we continue simulations 825. On completion of simulations, the system checks the compliance 830. Compliance checks 830 may be performed by another computer, for example one running only the link program 545 and the compliance analysis and artificial intelligence program 560. Compliance checks are performed by the CAAIE 120. The compliance analysis and artificial intelligence program 560 checks the compliance in 830 and determines if there are any non-compliances 835. Non-compliances are recorded in 830. If there are any non-compliances, the user is notified in block 840. Following block 840, the user choice to run documentation or not is entered in block 845. If the system is compliant in 835 or the user enters to produce documentation in 845, the system produces documentation 850. The document generation program 570 may run on a different computer to the other functions. Once the documentation is produced the system may continue 855 to take a new task from the UP 155 or may END 860.

FIG. 9 is a flow chart of an individual task method 900, according to an embodiment. Some or all of the operations of method 900 may be performed by one or more of the blocks of the core system 100, according to some embodiments. In some embodiments, a user may run a plurality of individual tasks at once. The method may run once or may repeat. The method begins at START. The SAM 105 loads the next system task in block 905, the task setup and data to be ingested is configured in the UP 155. In some embodiments of block 905, the user may schedule only a simulation, compliance analysis, plotting and or report generation task, or any combination thereof. For example, in block 905, the user may input data from a hardware test of a solar inverter to be overlayed with simulation results and configure how the core system 100 is to run the simulation and report. In block 910, the contents of the data provided is examined and if the content is not complete the user is notified in 920. In any case where the user is notified 920, the system then returns to 905, to load the next system task. If the package content is complete 910, then the system moves on to check for errors in the Ribbon Grid text file 915, to ensure the directives can be run correctly on the system. If there are errors the system notifies the user 920. If there are no errors, the system progresses to the setting calibration stage 925. In block 925, the system schedules both simulation and documentation tasks (which include plotting tasks as a sub task). If settings changes are commanded, this is also completed in block 925. Block 925 is the junction of rerun tasks, it is the beginning of looped solution operations, within a single system task. In some embodiments, blocks 905, 910, 915, 920 and 925 are completed by the SAM 105. The simulation tasks are allocated to specific computer(s) 470 identified in the Ribbon Grid file directives or system standard operation. Simulation tasks are performed and results obtained in 930, by the simulation program(s) 550. The link program 545 monitors the simulation progress and if any errors have occurred this is flagged in block 935. In the case an error has occurred in the simulation(s), the engineer is notified and the system tasks are cancelled 940. The difference of the usage of notify user versus notify engineer in the case of block 920 vs block 940 is that a user is conceptually an end user submitting tasks, whereas an engineer is working on the maintenance of the correct operation of the system. As such notify engineer 940, has a deeper level of inspection and correction available to attempt to solve an issue for all users. Notify user 920 is provided to allow a user to correct their individual inputs, namely the Ribbon Grid file directives or input data. In the case there is no simulation error 935, we continue simulations 945. On completion of simulations, the system checks the compliance 950. Compliance checks 950 may be performed by another computer, for example one running only the link program 545 and the compliance analysis and artificial intelligence program 560. Compliance checks are performed by the CAAIE 120. The compliance analysis and artificial intelligence program 560 checks the compliance in 950 and determines if there are any non-compliances 955. Non-compliances are recorded in 950. If there are any non-compliances, these studies may be rerun. The system checks if the Ribbon Grid file has directives to demand rerun on non-compliance event 960. If there is no rerun directive 960 or the system is compliant in 955, the system produces documentation 965. The document generation program 570 may run on a different computer to the other functions. Once the documentation is produced and a timestamp and an electronic signature is affixed to the report 970, in some embodiments. The documentation tasks are part of the DGS 130. If a verified package has been requested 975, then a verified package is produced 980. Once the verified package has not or has been produced (if requested) the process reaches the END 985.

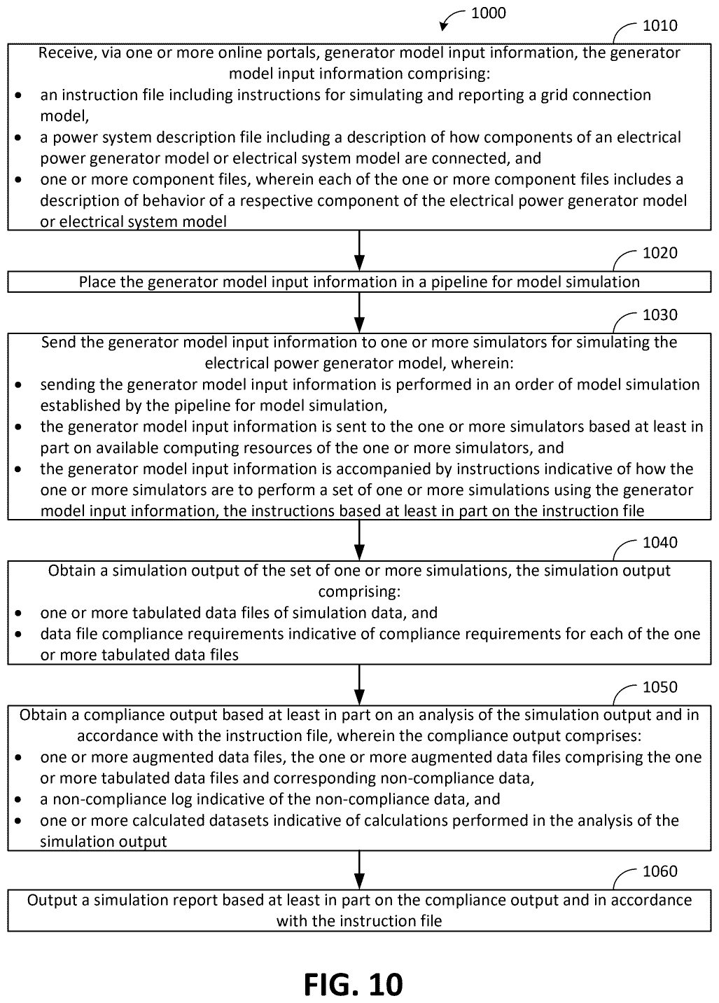

FIG. 10 is a flow diagram of a method 1000 of electrical grid connection simulation and reporting for distributed generators. Means and/or structure for performing the method 1000 may comprise one or more computers, such as the computers 470 of the physical system 400, described above, which may implement the core system 100 and other aspects of the embodiments described herein. The method 1000 may be viewed as an example implementation of various aspects of the embodiments described above. Alternative embodiments may implement various aspects in different ways, including executing the functionality shown in the blocks of FIG. 10 in a different order, in parallel, etc., or performing other such alterations of the functionality of blocks as shown. In particular implementations, a person of ordinary skill in the art will appreciate how such variations may be made while providing the same or similar functionality to the method 1000.

At block 1010, the functionality comprises receiving, via one or more online portals, generator model input information, the generator model input information comprising: an instruction file including instructions for simulating and reporting a grid connection model, a power system description file including a description of how components of an electrical power generator model or electrical system model are connected, and one or more component files, wherein each of the one or more component files includes a description of behavior of a respective component of the electrical power generator model or electrical system model. As noted in the embodiments described above, a generator model may be obtained via a portal (e.g., generator model portal 145). As also noted herein, embodiments may implement one or additional features, depending on desired functionality. For example, according to some embodiments, the grid connection model may comprise a generator model or a system model. Additionally or alternatively, the one or more online portals comprise at least two online portals. In such embodiments, the method 1000 may further comprise receiving grid connection models of different types via different online portals. The instruction file of method 1000 may comprise a Ribbon Grid file as described herein. As noted in the embodiments herein, according to some embodiments, the instruction file (e.g., Ribbon Grid file) may comprise a plain text file that includes parameters for the set of one or more simulations, the analysis of the simulation output, the simulation report, or any combination thereof.

At block 1020, the functionality comprises placing the generator model input information in a pipeline for model simulation. As noted herein, a pipeline (e.g., generator model pipeline 150) can allow for sorting of task priority between multiple engineers. As also discussed, different pipelines may be established. Thus, some embodiments of the method 1000 may comprise establishing different pipelines for grid connection models of different types. According to some aspects, the order of model simulation established by the pipeline for model simulation may be based at least in part on a priority associated with the generator model input information.

At block 1030, the functionality comprises sending the generator model input information to one or more simulators for simulating the electrical power generator model, wherein: sending the generator model input information is performed in an order of model simulation established by the pipeline for model simulation, the generator model input information is sent to the one or more simulators based at least in part on available computing resources of the one or more simulators, and the generator model input information is accompanied by instructions indicative of how the one or more simulators are to perform a set of one or more simulations using the generator model input information, the instructions based at least in part on the instruction file. As described herein, according to some embodiments, sending the generator model input information to the one or more simulators is performed by a scheduler and allocation module executed by the one or more computers. An example of such a scheduler is the schedule and allocation module (SAM) 105. For embodiments in which a scheduler and allocation module is used, the set of one or more simulations may comprise a first set of one or more simulations, and the scheduler and allocation module further may be configured to cause the one or more simulators to perform a second set of one or more simulations with one or more parameters that are different than one or more corresponding parameters used to perform the first set of one or more simulations. According to some embodiments of the method 1000, sending the generator model input information may be based at least in part on available computing resources of the one or more simulators comprises load balancing across the one or more computers.

At block 1040, the functionality comprises obtaining a simulation output of the set of one or more simulations, the simulation output comprising: one or more tabulated data files of simulation data, and data file compliance requirements indicative of compliance requirements for each of the one or more tabulated data files. As noted in the embodiments herein, simulators (e.g., simulators 110) may perform the set of one or more simulations. Moreover, the output may be obtained, for example, by a compliance analysis and artificial intelligence engine (CAAIE) and/or data collection engine (DCE). Further, according to some embodiments, a deep learning oversight module (DLOM) (e.g., DLOM 125) comprising a machine learning model may be executed, which may be configured to cause the one or more simulators to perform one or more additional simulations based at least in part on the compliance output, and adjust one or more settings in the generator model input information for the one or more additional simulations.

At block 1050, the functionality comprises obtaining a compliance output based at least in part on an analysis of the simulation output and in accordance with the instruction file, wherein the compliance output comprises: one or more augmented data files, the one or more augmented data files comprising the one or more tabulated data files and corresponding non-compliance data, a non-compliance log indicative of the non-compliance data, and one or more calculated datasets indicative of calculations performed in the analysis of the simulation output. As noted in the embodiments described above, some embodiments may further comprise performing the compliance. Such embodiments may comprise, for example, executing a compliance analysis module to obtain the compliance output, and executing a compliance analysis and artificial intelligence engine (CAAIE) comprising a machine learning model configured to: cause the compliance analysis module to perform one or more additional iterations of compliance analysis checks based at least in part on the CAAIE machine learning model, and cause the augmentation of one or more tabulated data files, the one or more augmented data files comprising the one or more tabulated data files and corresponding non-compliance data.

At block 1060, the functionality comprises outputting a simulation report based at least in part on the compliance output and in accordance with the instruction file. As noted herein, the simulation report may be provided in various ways. According to some embodiments, outputting the simulation report is performed by a document generation system (e.g., document generation system (DGS) 130) executed by the one or more computers. Outputting the simulation report may comprise making the simulation report available via a user portal (e.g., user portal (UP) 155). According to some embodiments, the set of one or more simulations may comprise at least two simulations. In such embodiments, the simulation report may include a graph with results from the at least two simulations. Additionally or alternatively, the set of one or more simulations may comprise at least two simulation programs, in which case the simulation report may include a graph with results from the at least two simulation programs. Is also indicated herein, a report (e.g., generated by the DGS 130 and/or document generator 240) may produce a number of different reports based on the System Operator of the region where the distributed generator is to be connected to the power grid. As such, the simulation report may comprise at least a portion of: a California ISO (CAISO) generator grid connection study report, a New York ISO (NYISO) generator grid connection study report, an Electric Reliability Council of Texas (ERCOT) generator grid connection study report, a Midcontinent Independent System Operator (MISO) generator grid connection study report, a New England Independent System Operator (NE-ISO) generator grid connection study report, a Southwest Power Pool (SPP) generator grid connection study report, a Pennsylvania-New Jersey-Maryland Interconnection (PJM) generator grid connection study report, an Alberta Electric System Operator (AESO) generator grid connection study report, an Independent Electricity System Operator (IESO) generator grid connection study report, an Australian Energy Market Operator (AEMO) generator grid connection study report, a Model Acceptance Test (MAT) report, a Model Quality Test (MQT) report, a Dynamic Model Acceptance Tests (DMAT) report, a Generator Performance Standard (GPS) report, a Distributed Generator System Impact study report, a Distributed Generator PQ Capability report, or any combination thereof.

As described herein, embodiments may include one or more of a variety of additional features with respect to outputting reports and/or implementing related functionality. For example, according to some embodiments, the simulation report may comprise a digital fingerprint created by a third party system or web application. Outputting the simulation report, in some embodiments, may further including a verified report comprising a verified version of the simulation report, the verified report further comprising the generator model input information and a HASH or other unique identifier associated with the generator model input information or a project associated with the generator model input information. In such embodiments, the verified report comprises the HASH, the method further may further comprise generating the HASH. Moreover, the verified report may include a link to a web page comprising: the HASH or other unique identifier, a date the set of one or more simulations were performed, names of files of the generator model input information, a time the simulation report was generated, a time when a user was notified, identifiers of the one or more computers, or any combination thereof. The method of claim 1, wherein outputting the simulation report comprises including a verified version of the simulation report in a verified package, the verified package further comprising the generator model input information and a HASH or other unique identifier associated with the generator model input information. Further, in some embodiments, the verified package may comprise the HASH, and the method may further comprise generating the HASH. Additionally or alternatively, the verified package includes a link to a web page comprising: the HASH or other unique identifier, names of all files in the verified package, times the files of the generator model input information were received by one or more computers, or any combination thereof. The method of claim 1, further comprising establishing a data collection engine (DCE) for storing: the instruction file, the one or more power system description files, the one or more component files, the one or more tabulated data files, the one or more augmented data files, the non-compliance log, the one or more calculated datasets, the simulation report, one or more flags associated with the electrical grid connection simulation, or any combination thereof.

### Ribbon Grid File Usage

The following description specifies various aspects of a Ribbon Grid file, according to some embodiments. As with other descriptions herein, the description of the Ribbon Grid file is provided as a non-limiting example. A person of ordinary skill in the art will appreciate how alternative embodiments may differ from the embodiment of the Ribbon Grid file described below, depending on desired functionality. For example, different naming conventions, syntax, and/or other aspects may be used while providing the same or similar functionality.

The Ribbon Grid file is supplied to many of the blocks within the system. The Ribbon Grid File is both an input document and a live document that describes: which simulators to use, the simulations to be performed, the computer(s) to be used (CPU details, GPU details, etc.), the region or jurisdiction of compliance, how the reporting is to be compiled, what simulation options to include, live system records and the HASH or unique identifier for each project or reporting task. The Ribbon Grid file may also include user comments.

The USER or ‘inputs’ section of the Ribbon Grid file begins with START USER it then describes: the simulators to use, the simulations to be performed, the region or jurisdiction of compliance and how the reporting is to be compiled. The input section of the Ribbon Grid file ends with END USER.

The SYSTEM_RECORD section of the Ribbon Grid file does not exist when uploaded by the user. If any non-comment text is included, after END USER (for example, data form a previous iteration), then it is automatically deleted by the Generator Model Pipeline 150 or the SAM 105.

The SYSTEM RECORD section of the Ribbon Grid file begins with START SYSTEM RECORD. The SYSTEM RECORD section of the Ribbon Grid file includes key live data information (primarily the unique HASH) and high level log data, such as the time SAM 105 received the request, tasks completed, etc.

The HASH is a unique project identifier that is used by a number of blocks including: SAM Block 105, CAAIE Block 120, DCE Block 115, DGS Block 130 and the DLOM Block 125.

Details of how the various components, or blocks, of the core system 100 use the HASH are provided in the detailed description of each block below.

In some embodiments, the plain text Ribbon Grid language (RG lang) in the USER or ‘inputs’ section of the Ribbon Grid file may be interpreted to direct the system functions. The plain text language may be processed through an interpreter or a compiler to then produce actionable system directives and operable code. In some embodiments, the plain text Ribbon Grid language may be referred to as ‘RG lang’.

In some embodiments, the UP 155 may supply a visual interface to build the plain text Ribbon Grid file. For example, it may supply a ‘Google Blockly’ interface or flow charts that then build the Ribbon Grid file.

In some embodiments, the plain text Ribbon Grid file may be split into two files. For example, there may be a Ribbon Grid file (RG file) that describes the USER section and a Ribbon Grid Output file (RGO file) that describes the SYSTEM RECORD section.

In some embodiments, the plain text Ribbon Grid file may refer to other plain text Ribbon Grid files or code files (Python, etc.), and the set of plain text Ribbon Grid files and code files may work together to describe a simulation and reporting task.

In some embodiments, the core system 100 may have access to two isolated script repositories. The first repository may have scripts and Ribbon Grid files that may comprise the intellectual property of the developer of the core system 100. The second script repository may contain scripts that may comprise the intellectual property of an engineering company. The second script repository may utilize the first script repository, in some embodiments. The scripts in either script repository may be editable through the UP 155 or the script editor 330.

In some embodiments, the Ribbon Grid language describes to the core system 100 how to run scripts supplied by an engineering company on the system of computers, utilizing one or more script repositories or libraries, located locally or on a cloud service (GitHub, etc.). According to some embodiments, rather than describing how to run the actual studies, the Ribbon Grid language may describe how to configure the execution, data management, and reporting on the core system 100.

The script linkage editor 320 allows the end user to create linkages between Ribbon Grid directives and company scripts to be executed on the computing resources 405. In some embodiments, a user may reference the company scripts that have been tailored for usage in the core system 100 by the company engineers. Once the code source is referenced, the script linkage editor 320 may allow the user to describe the simulations and reporting tasks to be performed using RG lang and supplied company scripts, on the core system 100.

In some embodiments, the Ribbon Grid file USER segment may be written in an existing coding language such as Python, Java etc.

The Ribbon Grid file may describe linkages to databases. Directives in the Ribbon Grid file may instruct the core system 100 or DCE 115 to copy key information to a database, for example plant megawatt size and reactive power profile etc.

Ribbon Grid file, specific example:
(comment) Ribbon Grid file for XYZ Solar Farm
This is a comment not used by the interpreter.
The - - - at the start of each line tells the interpreter to ignore these two lines.
START USER (this delineates the start of the User Inputs section for this specific project.)
run PSSe (this gives the system the directive to run PSSe simulation on all required compliance studies)
run PSCAD (this gives the system the directive to run PSCAD simulation on all required compliance studies)
include SMIB_STUDIES (this gives the system the directive to run Single Machine Infinite Bus studies)
include SYSTEM_STUDIES (this gives the system the directive to run system fault studies to see how the solar or wind farm response to system faults, faults run are dependent on point of connection).
snapshot CA_LATEST (this gives the system the directive use the latest snapshot of the whole California region, for system studies basis.)
region CA_ISO (this gives the system the directive to use scripts for the California ISO region)
run all_compliance (this gives the system the directive to use all scripts for the California ISO region)
output all_reports (this gives the system the directive to produce both PDF and interactive HTML reports.)
output verified package (this gives the system the directive to create a verified package of all inputs, outputs and RG file in one ZIP file, or other compressed file(s).)
END USER (this delineates the end of the User Inputs section for this specific project.)
START SYSTEM RECORD (this delineates the start of the system record section for this specific project.)
HASH 5b69e4b40ae63c601fb49e5067e142849a6e7f17 (this is an example of a HASH that is included the project and this HASH is unique to a simulation and reporting process)
SAM BEGUN 2024 Apr. 08 22:27:17 (this is the time the Scheduler and Allocation Module (SAM) Block began scheduling simulations with computers)
REPORT_GENERATED 2024 Apr. 08 22:29:18 (this is the time the document generation system finished documentation and provided files to the user portal)
END SYSTEM_RECORD (this delineates the start of the system record for this specific project)

### The Blocks: Inputs, Outputs and Detailed Descriptions

The core system 100 is depicted in FIG. 1. As illustrated, the core system 100 comprises 12 main blocks. The main blocks are described in detail below. Also, the inputs and outputs to these main blocks are listed. The DGS 130 block is composed of 4 sub-blocks (as illustrated in FIG. 2). The inputs, outputs and detailed descriptions are also provided for the sub-blocks below. The script management portal 160 block is composed of 4 sub-blocks (as illustrated in FIG. 3). The inputs, outputs and detailed descriptions are also provided for the sub-blocks below.

In this section, the blocks are described. The inputs, outputs and details are described. This explanation is a non-limiting example of an implementation. Inputs and outputs may be added, deleted, or unused in some embodiments.

### Generator Model Portal Block 145

### Inputs

1. Ribbon Grid File (plain text),
2. Power System Description File: a file that describes the busbars, powerlines, transformers and electrical components network, for example PSSe SAV files, PSCAD PSCX or PSLX files, Powerfactory PFD files, etc. and
3. Dynamic Description Files/Hardware Model Files: these files describe the dynamic performance of the Generator components. Generally there is a plant level controller and a plant description. For example: PSSe DYR files or the code from the Inverter and Power Plant Controller, such as DLL or LIB files in PSSe or PSCAD etc. The DLL or LIB files are produced by compiling code either from the real world inverter or that closely matches the real world inverter code. There may be multiple Dynamic Description Files and/or Hardware Model Files.

### Outputs: Same as Inputs

Detailed Description: The three inputs described are generally included in a folder, the folder having the project name. The Generator Model Portal 145 may allow a user to test the Ribbon Grid file to test whether it is correctly written. The Generator Model Portal 145 allows the user to load the submitted project files into Generator Model Pipeline 150. The Generator Model Portal 145 allows the user to prioritize their own specific projects, for example they may re-arrange the order of importance for processing.

### Generator Model Pipeline Block 150

### Inputs

1. Ribbon Grid File (plain text),
2. Power System Description File: a file that describes the busbars, powerlines, transformers and electrical components network, for example PSSe SAV files, PSCAD PSCX or PSLX files, Powerfactory PFD files, etc. and
3. Dynamic Description Files/Hardware Model Files: these files describe the dynamic performance of the Generator components. Generally, there is a plant level controller and a plant description. For example: PSSe DYR files or the code from the Inverter and Power Plant Controller, such as DLL or LIB files in PSSe or PSCAD etc. The DLL or LIB files are produced by compiling code either from the real world inverter or that closely matches the real world inverter code. There may be multiple Dynamic Description Files and/or Hardware Model Files.

### Outputs: Same as Inputs

Detailed Description: Project files in the Generator Model Pipeline 150 will be processed by the system once reaching the first position in the queue. The Generator Model Pipeline 150 is global. That is, it may have queued tasks from multiple different users or companies. The tasks may be prioritized based on the importance of a company. For example, tasks from system operators may be processed before or at a higher priority or at a higher runtime utilization than tasks from engineering consultancies.

The SYSTEM_RECORD section of the Ribbon Grid File should not exist when uploaded by the user. If any non-comment text is included, after END USER, then it is automatically deleted by the Generator Model Pipeline 150.

### System Model Portal Block 135

### Inputs

1. Power System Description File: a file that describes the busbars, powerlines, transformers and electrical components network, for example PSSe SAV files, PSCAD PSCX or PSLX files, Powerfactory PFD files, etc. and
2. Dynamic Description Files/Hardware Model Files: these files describe the dynamic performance of the Generator components. Generally, there is a plant level controller and a plant description. For example: PSSe DYR files or the code from the Inverter and Power Plant Controller, such as DLL or LIB files in PSSe or PSCAD, etc. The DLL or LIB files are produced by compiling code either from the real world inverter or that closely matches the real world inverter code. There may be multiple Dynamic Description Files and/or Hardware Model Files. For large systems, sometimes the dynamic models of all the plants and controllers in the power network are compiled into one large DLL or LIB.

### Outputs: Same as Inputs

Detailed Description: The two inputs described are generally included in a folder, the folder having the snapshot name. A snapshot is a moment in time of the electrical system. For example, Northern California electrical system 4 Jul. 2021. Sometimes snapshots are correlated with a system loading event, for example 2023 Summertime peak, etc. The System Model Portal 135 may allow System Operators, Utilities and engineering companies to load system snapshots into the processing system so users can specify the addition of their generator to a specific system snapshot for system fault testing.

### System Model Pipeline Block 140

### Inputs

1. Power System Description File: a file that describes the busbars, powerlines, transformers and electrical components network, for example PSSe SAV files, PSCAD PSCX or PSLX files, Powerfactory PFD files, etc. and
2. Dynamic Description Files/Hardware Model Files: these files describe the dynamic performance of the Generator components. Generally there is a plant level controller and a plant description. For example: PSSe DYR files or the code from the Inverter and Power Plant Controller, such as DLL or LIB files in PSSe or PSCAD, etc. The DLL or LIB files are produced by compiling code either from the real world inverter or that closely matches the real world inverter code. There may be multiple Dynamic Description Files and/or Hardware Model Files. For large systems, sometime the dynamic models of all the plants and controllers in the power network are compiled into one large DLL or LIB.

### Outputs

Database of inputs, snapshots of the electricity system.

### Detailed Description

The System Model Pipeline 140 can be used by System Operators, Utilities and engineering companies to load snapshots of the power system for different regions. This then allows users to have the automated system add their solar farms, wind farms etc. to the specified system and run common fault studies.

The System Model Pipeline 140 can be used by System Operators, Utilities and engineering companies to load the latest data into the system so that users are not missing any recently commissioned solar farms from their studies. This is a common problem that recently commissioned farms are excluded. This is an issue as interactions can occur between distributed generators.

### Specific Example

### Ribbon Grid File Contains

snapshot CA_LATEST
include SYSTEM_STUDIES

These Ribbon Grid File directives instruct the system to use the latest snapshot of the whole California region, for the system studies basis. Also, they give the system the directive to run system fault studies to see how the solar or wind farm response to system faults. Note that exact faults can also be described, or the faults can be automatically run based on the point of interconnection of the distributed generator.

### Script Management Portal Block 160

### Inputs

1. List of available Ribbon Grid files or scripts that can be run on the system (RG files, Python files etc.),
2. A description (visual and/or text based) of the linkage of each script to the Ribbon Grid file directives. The text version is known as the Ribbon Grid script linkage file.

### Outputs: Same as Inputs

### Detailed Decsription

The script management portal block 160 comprises four sub blocks, as illustrated in FIG. 3. The functions of the sub block make up the functionality of the script management portal block 160. The description of the sub blocks provided below is in reference to the numbering in FIG. 3.

### Script Linkage Viewer Block 310

### Inputs

1. List of available Ribbon Grid files or scripts that can be run on the system (RG files, Python files etc.),
2. A description (visual and/or text based) of the linkage of each script to the Ribbon Grid file directives. The text version is known as the Ribbon Grid script linkage file.

### Outputs: Same as Inputs

### Detailed Description

The script linkage viewer block allows the user to view, a description (visual and/or text based) of the linkage of each script to the Ribbon Grid file directives. The interface also provides a read only preview of linked scripts.

The script linkage viewer block 310 may include elements of the version control system 340.

### Script Linkage Editor Block 320

### Inputs

1. List of available Ribbon Grid files or scripts that can be run on the system (RG files, Python files etc.),
2. A description (visual and/or text based) of the linkage of each script to the Ribbon Grid file directives. The text version is known as the Ribbon Grid script linkage file.

### Outputs: Same as Inputs

### Detailed Description

The script linkage editor block allows the user to view and edit, a description (visual and/or text based) of the linkage of each script to the Ribbon Grid file directives.

The script linkage editor block 320 may include elements of the version control system 340.

### Script Editor Block 330

### Inputs

1. List of available Ribbon Grid files or scripts that can be run on the system (RG files, Python files etc.),

### Outputs: Same as Inputs

### Detailed Description

The script editor block allows the user to view and edit, the scripts internal to the system, including the scripts that automate the studies.

The script editor block 330 may include elements of the version control system 340.

### Version Control System Block 340

### Inputs

1. Old versions of files

### Outputs

1. New versions of files, and
2. Records of changes (known as changesets).

### Detailed Description

The version control system stores the old and new versions of files. As files are edited over time, the change sets are stored. Thus, the user can access the full history of all edits to the files. In this application, the main tracked files may include: the Ribbon Grid files, the Ribbon Grid linkage description files and the scripts (Python etc.).

The version control system may be implemented as project name linked. That is, anything for the ‘XYZ Solar Farm’ project has version control linked to the same directory or repository.

### Simulators Block 110

### Inputs

1. Ribbon Grid File (plain text),
2. Power System Description File: a file that describes the busbars, powerlines, transformers and electrical components network, for example PSSe SAV files, PSCAD PSCX or PSLX files, Powerfactory PFD files, etc. and
3. Dynamic Description Files/Hardware Model Files: these files describe the dynamic performance of the Generator components. Generally there is a plant level controller and a plant description. For example: PSSe DYR files or the code from the Inverter and Power Plant Controller, such as DLL or LIB files in PSSe or PSCAD, etc. The DLL or LIB files are produced by compiling code either from the real world inverter or that closely matches the real world inverter code. There may be multiple Dynamic Description Files and/or Hardware Model Files.
4. Scripts Code Library or Scripts.
5. Data end point(s): a location to transfer the data to, the location of the DCE 115.

### Outputs

Tabulated data files (for example CSV files) of simulation data,

Individual Datafile Compliance Requirements. That is, details on what each datafile should comply with. In some embodiments, this may be included in the Ribbon Grid System Record, in other instances this may be solely based on the file names created, in other instances this information will be recorded in a different file. Details of what studies relate to which filename.

### Detailed Description

The simulators block contains code wrapped simulators. In some embodiments, languages such as Python, R, Java etc. may be used to wrap the simulator. That is the simulation programs are controlled by a coded wrapper program. Based on the Ribbon Grid File region and run directives, certain commands and scripts are to be run and certain filenames are created. In some embodiments, additional data is stored which details what studies performed relate to which filename.

The commands and scripts are provided to the Simulators 110 Block in one of two ways. The commands and scripts are passed in from the SAM 105 which holds a scripts library, or the whole scripts library is contained on the computer 470 responsible for running the simulations. Thus, in this second embodiment the scripts can be accessed by script name. In either embodiment, the Ribbon Grid File Interpreter processes the Ribbon Grid File and determines which scripts are to be run for the Ribbon Grid File provided for the project.

On completion of a simulation, the simulator block copies the data to the provided HASH end point for the project, on the DCE 115.

### Specific Example

Ribbon Grid File Contains:
region CA_ISO
run all_compliance

In this embodiment the Ribbon Grid File Interpreter will run all of the scripts related to California ISO testing and run them in the order demanded by all_compliance.

### Scheduler and Allocation Module (SAM) Block 105

### Inputs

1. Ribbon Grid File (plain text),
2. Power System Description File (a file that describes the busbars, powerlines, transformers and electrical components network, for example PSSe SAV files, PSCAD PSCX or PSLX files, Powerfactory PFD files), and
3. Dynamic Description Files/Hardware Model Files (these files describe the dynamic performance of the Generator components. Generally there is a plant level controller and a plant description. For example: PSSe DYR files or the code from the Inverter and Power Plant Controller, such as DLL or LIB files in PSSe or PSCAD. The DLL or LIB files are produced by compiling code either from the real world inverter or that closely matches the real world inverter code. There may be multiple Dynamic Description Files and/or Hardware Model Files.
4. Scripts Code Library or Scripts.
5. Ribbon Grid Script Linkage Description file: Describes how the Ribbon Grid plain text directives relate to the script usage (python files etc.).

### Outputs

1. SAM TASKS COMPLETE flag, and other error signals and flags.
2. Data end point(s): a location for the simulation and documentation tasks to transfer data to, the location of the DCE 115.

### Detailed Description

The SAM 105 Block is responsible for scheduling and monitoring of all simulation tasks. The SAM 105 may the scheduling work for a number of projects and sending the work to a number of rack supercomputers, or a computer in a system of computers, at any one time. The SAM 105 is also responsible for load balancing of all the simulation workload across the simulation supercomputers.

Before beginning scheduling work for a specific project the SAM 105 will check with the DCE 115 block (via a message bus) that a specific hash endpoint for the project data storage exists.

The simulators block contains code wrapped simulators. That is the simulation programs are controlled by code (Python etc.). The SAM 105 tells the simulator block (via a message bus) exactly what commands or scripts to run on exactly what input files (PSSe, PSCAD files etc.).

The scripts are provided to the Simulators 110 Block in one of two ways. The commands and scripts are passed in from the SAM 105 which holds the scripts library, or the whole scripts library is contained on the supercomputer responsible for running the simulations. Thus, in this second embodiment the scripts can be accessed by script name sent by the SAM 105, or a local Ribbon Grid file interpreter or compiler.

The SAM 105 may confirm data integrity of the results datafiles before determining a simulation set to be complete.

### Specific Example

For example, A project is received by the SAM 105 from the generator model pipeline. Part A of Project A is run on supercomputer 1 whereas Part B of Project A runs on supercomputer 5. Each simulator copies the data to the HASH endpoint on the DCE 115. The SAM 105 confirms data integrity of the results datafiles before determining a simulation set to be complete. The SAM 105 marks simulations complete in the system record for the project.

### Compliance Analysis and Artificial Intelligence Engine (CAAIE) Block 120

The CAAIE 120 block contains two modules, the compliance analysis module and the artificial intelligence module.

### Inputs

1. Ribbon Grid File (plain text),
2. Tabulated data files (for example CSV files) of simulation data,
3. Individual Datafile Compliance Requirements. That is, details on what each datafile should comply with. In some embodiments, this may be included in the Ribbon Grid System Record, in other instances this may be solely based on the file names created, in other instances this information may be recorded in a different file.

### Outputs

1. Augmented Datafiles that now include non-compliance data.
2. Non-compliance log file.
3. Additional calculated datasets such as: rise times, settling times, overvoltage duration, overvoltage magnitude, bounce height, oscillation magnitude, oscillation decay rate and oscillation duration etc.

### Detailed Description

This module is a novel feature of the system. This module is a first of its kind proposal. This work is normally undertaken by humans and is very difficult to automate. It is impossible for a human to perform complex multivariable mathematics in a single pass. It may take one engineer weeks to complete the investigation, it takes this module only minutes. Some engineers without PhD degrees may be incapable of understanding the complex mathematics involved.

The Ribbon Grid file describes what studies have been undertaken in simulation. Based on what studies have been undertaken in simulation and the individual data file compliance requirements the module works on scanning through all of the data to find non compliances with mathematical algorithms.

Generally, in grid connection studies there may be 10 or more mathematical algorithms that have been derived from the innovation of the company based around ways to detect non-compliance. These algorithms are run continuously while scanning through the data to find non compliances. The Ribbon Grid file and individual data file compliance requirements inform the compliance analysis module and the artificial intelligence module the non-compliances to look for in each individual data file (CSV normally).

The compliance analysis module and the artificial intelligence module operate simultaneously. The compliance analysis module and the artificial intelligence module differ in the algorithms that they can implement. The compliance analysis module can implement mathematical calculations that are generally direct linear mathematics. For example, calculating a rise time where the start of the rise is known. The artificial intelligence module can implement complex multivariable algorithms. For example, detecting when an oscillation begins and what window (i.e. start time, end time) to use on the data set then run a mathematical calculation such as a frequency sweep phase locked loop to lock to the frequency and decay rate.

### Specific Example 1

Grid codes require a reactive power rise and settling times faster than 80 milliseconds and 150 milliseconds respectively. Reactive power rise and settling time are calculated based on simulation data. Any non-compliance detected by the system is recorded in the augmented data set and the non-compliance log file.

### Specific Example 2

The Single Machine Infinite Bus (SMIB) model is run and the frequency of the grid source is increased to ensure the generator curtails output power when frequency increases. The grid codes provide a mathematical equation for Power relative to Frequency. The compliance analysis understands based on the data filename, or instructions, that the frequency curtailment should be checked on this datafile. The compliance analysis module scans the file data and tests each datapoint against the equation requirements. The compliance analysis module adds an extra column to the results CSV for example “Non-compliances”. Any points that are non-compliant are duplicated into this new column. Where the data point is compliant the entry is NULL or NONE. These non-compliant data segments are also noted in the non-compliance log file.

### Specific Example 3

Artificial intelligence (AI) is engaged to tune the filter to scan the file to lock onto any oscillation at certain frequencies, for example: in the range of 100 Hz to 1 Hz. Detecting an oscillation, the AI chooses what window (i.e start time, end time) to use on the data set. The AI then runs algorithms such as a frequency sweeping phase locked loop to lock to the frequency and another algorithm addition to deduce the decay rate. Any points that are non-compliant are duplicated into this new column. Where the data point is compliant the entry is NULL or NONE. These non-compliant data segments are also noted in the non-compliance log file.

### Data Collection Engine (DCE) Block 115

### Inputs

1. Ribbon Grid File (plain text),
2. Tabulated data files (for example CSV files) of simulation data,
3. Individual Datafile Compliance Requirements. That is, details on what each datafile should comply with. In some embodiments, this may be included in the Ribbon Grid System Record, in other instances this may be solely based on the file names created, in other instances this information may be recorded in a different file.
4. Augmented Datafiles that now include non-compliance data.
5. Non-compliance log file.
6. Additional calculated datasets such as: rise times, settling times, overvoltage duration, overvoltage magnitude, bounce height, oscillation magnitude, oscillation decay rate and oscillation duration etc.
7. Any supplemental or additional data to be stored in the DCE 115.

### Outputs

1. Per project file hosting location (for example, an FTP location based on the project HASH or a symbolic link or an alternate data storage ENDPOINT).
2. STUDIES_COMPLETE flag, and other flags.

### Detailed Description

The DCE 115 receives an input that a new project has been created via a message bus. The DCE 115 creates a data collection endpoint based on the hash of the project. The data collection endpoint is available for the storage of simulation results files by multiple blocks. The data collection endpoint is available as data access for many different blocks including but not limited to the SAM 105, the CAAIE 120, the DLOM 125 and the DGS 130.

### Documentation Generation System (DGS) Block 130

### Inputs

1. Ribbon Grid File (plain text),
2. Tabulated data files (for example CSV files) of simulation data,
3. Individual Datafile Compliance Requirements.
4. Augmented Datafiles that now include non-compliance data.
5. Non-compliance log file.
6. Additional calculated datasets such as: rise times, settling times, overvoltage duration, overvoltage magnitude, bounce height, oscillation magnitude, oscillation decay rate and oscillation duration etc.
7. Document templates,
8. Additional and supplemental data, company logo's etc.

### Outputs

1. Reports: Grid Studies Report, Model Quality Reports etc. (PDF, DOCX, HTML, ‘Plotly Dash’ apps etc.),
2. Non-compliance log report,
3. Generator Performance Standard Documents (PDF, DOCX),
4. Verified Reports and Verified Packages.

### Detailed Description

The DGS Block 130 comprises four subblocks, as illustrated in FIG. 2: Document Generator Subblock 240, Plotting Module Subblock 210, Electronic Datestamp/Signature Module Subblock 220 and Verified Package Creation Module Subblock 230. The description of the sub blocks provided below is in reference to the numbering in FIG. 2.

The document generation system generates reports in PDF, DOCX, HTML and ‘Plotly Dash’ app formats, verified reports and verified packages. The documents and packages are then provided to the User Portal 155.

### Plotting Module Subblock 210

### Inputs

1. Ribbon Grid File (plain text),
2. Individual Datafile Compliance Requirements.
3. Augmented Datafiles that now include non-compliance data.
4. Non-compliance log file.
5. Additional calculated datasets such as: rise times, settling times, overvoltage duration, overvoltage magnitude, bounce height, oscillation magnitude, oscillation decay rate and oscillation duration etc.

### Outputs

1. Image Files (JPEG, PNG, GIF etc.) and
2. HTML Files of plotted results data.

### Detailed Description

The plotting module sub block creates visualizations in the form of image files and HTML files with interactive zoom (Plotly etc.). The image files are generally two-dimensional or three-dimensional datasets that represent the performance of the solar farm or wind farm. Annotations of non-compliances are added to the graphs based on the Augmented Datafiles that include non-compliance data from the CAAIE 120.

### Specific Example

The Numpy and Plotly Python packages may be used to load datasets from the CSV results files and produce GIF images of Voltage, Current and Power VS time graphs. The Numpy and Plotly Python packages may be used to load datasets from the CSV results files and produce HTML Plotly plots or datastores of Voltage, Current and Power VS time graphs, which contain all the datapoints and allow interactive zoom down to a single datapoint. Annotations of non-compliances are added to the graphs based on the Augmented Datafiles that include non-compliance data. Annotation may include for example, rise and settling times or accuracy bands, five percent for example.

### Document Generator Subblock 240

### Inputs

1. Ribbon Grid File (plain text),
2. Individual Datafile Compliance Requirements.
3. Augmented Datafiles that now include non-compliance data.
4. Non-compliance log file.
5. Additional calculated datasets such as: rise times, settling times, overvoltage duration, overvoltage magnitude, bounce height, oscillation magnitude, oscillation decay rate and oscillation duration etc.
6. Image Files (JPEG, PNG, GIF etc.) and
7. HTML Files of plotted simulation data.

### Outputs

1. Reports: Grid Studies Reports, Model Quality Reports etc. (PDF, DOCX, HTML, ‘Plotly Dash’ apps etc.),
2. Non-compliance log report,
3. Generator Performance Standard Documents (PDF, DOCX),
4. Verified Reports and Verified Packages.

### Detailed Description

The Document Generator subblock collates all the images produced by the Plotting Module subblock into reports. The Document Generator subblock adds figure captions, formatting and titles to reports. It will produce a complete Grid Studies Report in one or more of the following formats PDF, DOCX, HTML, ‘Plotly Dash’ apps etc. The reports it produces are based on directives in the Ribbon Grid file.

The Document Generator subblock may include text generated by Generative AI that creates full paragraphs about, for example, the ‘rise times’ and other additional calculated datasets related to the graphical results, the title, the site details, etc.

The Document Generator subblock creates a PDF non-compliance report based on the Non-compliance log file.

The Document Generator subblock creates a title page for the report including the HASH and linked QR code that connects to a web hosted record.

The Document Generator subblock creates engineering documents required in the grid connection process. For example, a Generator Performance Standard Document which describes the exact capabilities of the Solar Farm or Wind Farm at the Point of Interconnection to the power system. This may include PQ characteristics and dynamic performance capabilities as assessed by the CAAIE 120.

### Specific Example

The document generator creates a ‘Plotly Dash’ app where each HTML page (including multiple Plotly plots) represents a report section. The end user can browse the full report rendered in HTML by a ‘Plotly Dash’ app within the document generation program 570.

### Electronic Datestamp/Signature Module Subblock 220

Inputs: Ribbon Grid file, all filenames, all file sizes, all system records.

### Outputs

Unique HASH Identifier.
HASH Linked Unique QR Code.
Data record for User Portal Weblink for the Report containing all the simulation and system record information.
Data record for User Portal Weblink for the Verified package including all the files information, names, upload dates, upload users etc.

### Detailed Description

One of the novel features of the system is the ‘verified simulation/report’ feature, this involves the generation of a Unique HASH Identifier and linked QR Code. This unique HASH and linked QR code will be presented on the front page of the report. The HASH and linked QR code will link to a web page hosted by the company running the automated reporting system. The web page may show: the input file names, the date the simulations were performed, server record identifiers such as hashes or numbers, the time the report was generated, the time when the user was notified and/or the exact names hardware servers that completed the simulations. In this way, this module creates a ‘verified’ simulation report. The HASH and linked QR code cannot be copied to a different fraudulent report, as the hosted web record will show the fraud perpetrated. The company using the service cannot change the date, as the exact timing of the system use is documented via the HASH and linked QR code and connected web hosted record.

In the case of the Verified package, the Electronic Datestamp/Signature Module Subblock will create an independent HASH for the package itself. The web page for the package will show: all the filenames and file information, file upload dates, file upload users, time and date package created etc.

### Verified Package Creation Module Subblock 230

### Inputs

All input files used in the project and all output files created for the project.

### Outputs

Single Zip File, or Single Project contained in a number of Linked Compressed Files (size dependent).

### Detailed Description

Verified package creation module will output a single zip file in the case that the size is permitting. In the case the files are all of a larger size it will produce a single project contained in a number of compressed files which are linked and representative of one compressed project.

In this case the report will have a specific HASH identify, and the compressed verified package will also have a specific HASH identity. That is for a project with a Verified Package requested to be created two HASHes will be created for one project. One for the report itself and another for the package.

### Specific Example

The Verified Package HASH is independent to a report HASH. A specific package report (PDF file) may be included in the zip file which details all of the file names included in the zip file. This package HASH connects to a web link that fully describes the package details.

### Deep Learning Oversight Module (DLOM) Block 125

Inputs: Ribbon Grid file, All Data, Internal Deep Learnt Memory.

Outputs: Changes to inverter and power plant controller settings, Re-run required signal, Internal Deep Learning Memory.

### Detailed Description

This block deals with volumes of data not possible to be processed by humans. Each of the simulations may contain data at timesteps of 10 microseconds to 500 microseconds, over a 3 second period for example. This is 300,000 to 6,000 datapoints per 3 seconds of signal, for many signals; voltage, current etc. Using this amount of data to determine the ideal inverter setting, or a desirable power plant controller setting to meet compliance is complex. This requires supercomputer driven deep learning.

The DLOM 125 analyses very complex waveforms that may have resonance, low bandwidth re-settling, high bandwidth fast jumps, bounces, oscillations and/or decaying oscillations etc. Furthermore, there are multiple waveforms at the point of connection; voltage, current, power etc. and multiple waveforms at the inverter terminals; voltage, current, power etc. In some embodiments, there may be only one setting in the inverter or power plant controller that needs to be retuned, in other embodiments there may be 10 settings or more that need to be altered. For example, points on a diQdv curve. Further, the settings may be inter-related, that is an increase in one setting may require a comparative decrease (re-tuning) of another setting. The volume of data, large number of settings to change and the complexities of the waveforms require deep learning to deduce the settings in one or a few iterations. The alternative is a brute force approach that may require thousands or tens of thousands of iterations, which may be commercially unviable with the supercomputer resources and may take days of compute time.

### Specific Example

The user configures the system, by Ribbon Grid file directives, such that if a non-compliance is detected (with the users chosen settings for the solar inverters and power plant controller) for the utility scale solar farm then deep learning will be used to recalibrate the settings. The first run of studies is completed and the CAAIE 120 detects that the system is non-compliant with the regional standards. The DLOM 125 takes control of rerunning the simulations to achieve compliance. Based on all of the knowledge the deep learning has learnt over all time, it selects the best settings for the solar inverters and power plant controller and gains compliance for the utility scale solar farm in minutes.

### User Portal (UP) Block 155

Inputs: Ribbon Grid file, Original Datafiles (simulation results), Augmented Datafiles that now include non-compliance data, Non-compliance logfile in PDF or plain text format, Reports, Verified Reports and Verified Document Packages.

Outputs: File Download Interface, Online File Viewer, Online Report Viewer and web hosted verified HASH links, text or script editor and various graphical user interfaces.

### Detailed Description

The User Portal provides a web hosted location where the User can download the system outputs. The User can also configure the Notification settings or automated emailing of output reports to a specified email address.

### Specific Example 1

After completion of the studies and reporting by the system the user is emailed that it is complete. The user then logs on to the user portal and downloads their data. The user may view the report on the user portal.

### Specific Example 2

The user may get a report from a third party and want to verify it they scan the QR code which is based on the hash this gets them to a web hosted verified page that details the verified information.

### Clauses

In view of this description, embodiments may include different combinations of features. Implementation examples are described in the following numbered clauses:
Clause 1: A method of electrical grid connection simulation and reporting for distributed generators performed by one or more computers, the method comprising: receiving, via one or more online portals, generator model input information, the generator model input information comprising: an instruction file including instructions for simulating and reporting a grid connection model, a power system description file including a description of how components of an electrical power generator model or electrical system model are connected, and one or more component files, wherein each of the one or more component files includes a description of behavior of a respective component of the electrical power generator model or electrical system model; placing the generator model input information in a pipeline for model simulation; sending the generator model input information to one or more simulators for simulating the electrical power generator model, wherein: sending the generator model input information is performed in an order of model simulation established by the pipeline for model simulation, the generator model input information is sent to the one or more simulators based at least in part on available computing resources of the one or more simulators, and the generator model input information is accompanied by instructions indicative of how the one or more simulators are to perform a set of one or more simulations using the generator model input information, the instructions based at least in part on the instruction file; obtaining a simulation output of the set of one or more simulations, the simulation output comprising: one or more tabulated data files of simulation data, and data file compliance requirements indicative of compliance requirements for each of the one or more tabulated data files; obtaining a compliance output based at least in part on an analysis of the simulation output and in accordance with the instruction file, wherein the compliance output comprises: one or more augmented data files, the one or more augmented data files comprising the one or more tabulated data files and corresponding non-compliance data, a non-compliance log indicative of the non-compliance data, and one or more calculated datasets indicative of calculations performed in the analysis of the simulation output; and outputting a simulation report based at least in part on the compliance output and in accordance with the instruction file.
Clause 2: The method of clause 1, wherein the instruction file comprises a plain text file that includes parameters for the set of one or more simulations, the analysis of the simulation output, and the simulation report.
Clause 3: The method of either of clauses 1 or 2, wherein sending the generator model input information to the one or more simulators is performed by a scheduler and allocation module executed by the one or more computers.
Clause 4: The method of clause 3, wherein: the set of one or more simulations comprises a first set of one or more simulations; and the scheduler and allocation module is further configured to cause the one or more simulators to perform a second set of one or more simulations with one or more parameters that are different than one or more corresponding parameters used to perform the first set of one or more simulations.
Clause 5: The method of any one of clauses 1-4, wherein sending the generator model input information based at least in part on available computing resources of the one or more simulators comprises load balancing across the one or more computers.
Clause 6: The method of any one of clauses 1-5, further comprising executing a compliance analysis module to obtain the compliance output, and executing a compliance analysis and artificial intelligence engine (CAAIE) comprising a machine learning model configured to: cause the compliance analysis module to perform one or more additional iterations of compliance analysis checks based at least in part on the CAAIE machine learning model; and cause the augmentation of one or more tabulated data files, the one or more augmented data files comprising the one or more tabulated data files and corresponding non-compliance data.
Clause 7: The method of any one of clauses 1-6, further comprising executing a deep learning oversight module (DLOM) comprising a machine learning model configured to: cause the one or more simulators to perform one or more additional simulations based at least in part on the compliance output, and adjust one or more settings in the generator model input information for the one or more additional simulations.
Clause 8: The method of any one of clauses 1-7, wherein the grid connection model comprises a generator model or a system model.
Clause 9: The method of any one of clauses 1-8, wherein the one or more online portals comprise at least two online portals, wherein the method further comprises receiving grid connection models of different types via different online portals.
Clause 10: The method of any one of clauses 1-9, further comprising establishing different pipelines for grid connection models of different types.
Clause 11: The method of any one of clauses 1-10, wherein the order of model simulation established by the pipeline for model simulation is based at least in part on a priority associated with the generator model input information.
Clause 12: The method of any one of clauses 1-11, wherein outputting the simulation report is performed by a document generation system executed by the one or more computers.
Clause 13: The method of any one of clauses 1-12, wherein outputting the simulation report comprises making the simulation report available via a user portal.
Clause 14: The method of any one of clauses 1-13, wherein the set of one or more simulations comprises at least two simulations, and wherein the simulation report includes a graph with results from the at least two simulations.
Clause 15: The method of any one of clauses 1-14, wherein the set of one or more simulations comprises at least two simulation programs, and wherein the simulation report includes a graph with results from the at least two simulation programs.
Clause 16: The method of any one of clauses 1-15, wherein the simulation report comprises at least a portion of: a California ISO (CAISO) generator grid connection study report, a New York ISO (NYISO) generator grid connection study report, an Electric Reliability Council of Texas (ERCOT) generator grid connection study report, a Midcontinent Independent System Operator (MISO) generator grid connection study report, a New England Independent System Operator (NE-ISO) generator grid connection study report, a Southwest Power Pool (SPP) generator grid connection study report, a Pennsylvania-New Jersey-Maryland Interconnection (PJM) generator grid connection study report, an Alberta Electric System Operator (AESO) generator grid connection study report, an Independent Electricity System Operator (IESO) generator grid connection study report, an Australian Energy Market Operator (AEMO) generator grid connection study report, a Model Acceptance Test (MAT) report, a Model Quality Test (MQT) report, a Dynamic Model Acceptance Tests (DMAT) report, a Generator Performance Standard (GPS) report, a Distributed Generator System Impact study report, a Distributed Generator PQ Capability report, or any combination thereof.
Clause 17: The method of any one of clauses 1-16, wherein the simulation report comprises a digital fingerprint created by a third party system or web application.
Clause 18: The method of any one of clauses 1-17, wherein outputting the simulation report comprises including a verified report comprising a verified version of the simulation report, the verified report further comprising the generator model input information and a HASH or other unique identifier associated with the generator model input information or a project associated with the generator model input information.
Clause 19: The method of clause 18, wherein the verified report comprises the HASH, the method further comprising generating the HASH.
Clause 20: The method of any one of clauses 18-19, wherein the verified report includes a link to a web page comprising: the HASH or other unique identifier, a date the set of one or more simulations were performed, names of files of the generator model input information, a time the simulation report was generated, a time when a user was notified, identifiers of the one or more computers, or any combination thereof.
Clause 21: The method of any one of clauses 1-20, wherein outputting the simulation report comprises including a verified version of the simulation report in a verified package, the verified package further comprising the generator model input information and a HASH or other unique identifier associated with the generator model input information.
Clause 22: The method of any one of clauses 1-21, wherein the verified package comprises the HASH, the method further comprising generating the HASH.
Clause 23: The method of any one of clauses 1-22, wherein the verified package includes a link to a web page comprising: the HASH or other unique identifier, names of all files in the verified package, times the files of the generator model input information were received by one or more computers, or any combination thereof.
Clause 24: The method of any one of clauses 1-23, further comprising establishing a data collection engine (DCE) for storing: the instruction file, the one or more power system description files, the one or more component files, the one or more tabulated data files, the one or more augmented data files, the non-compliance log, the one or more calculated datasets, the simulation report, one or more flags associated with the electrical grid connection simulation, or any combination thereof.
Clause 25: The method shown any one of FIGS. 6-9.
Clause 26: A computer comprising: one or more communication interfaces; one or more memories; and one or more processors communicatively coupled with the one or more communication interfaces and the one or more memories, the one or more processors configured to perform the method of any one of clauses 1-25.
Clause 27: A system of networked computers configured to perform the method of any one of clauses 1-25.
Clause 28: An apparatus or system of apparatuses having means for performing the method of any one of clauses 1-25.
Clause 29: A non-transitory computer-readable medium storing instructions, the instructions comprising code for performing the method of any one of clauses 1-25.

1. A system for generating a compliance output for distributed electrical power generators, the system comprising:
one or more computers, wherein each of the one or more computers respectively comprise one or more communication interfaces, one or more memories, and one or more processors communicatively coupled with the one or more communication interfaces and the one or more memories, and wherein the one or more computers are configured to:
obtain a simulation output of a first set of one or more simulations of an electrical power generator model or electrical system model, the simulation output comprising:
one or more tabulated data files of simulation data, and
data file compliance requirements indicative of compliance dynamic performance requirements for each of the one or more tabulated data files to meet to comply with grid codes of a jurisdiction of compliance;
determine, with a first machine learning model, a non-compliance within the simulation output based at least in part on an analysis of the simulation output and in accordance with an instruction file, the non-compliance comprising a failure of at least one tabulated data file of the one or more tabulated data files to meet the data file compliance requirements;
generate the compliance output, wherein the compliance output comprises:
one or more augmented data files, the one or more augmented data files comprising the one or more tabulated data files and corresponding non-compliance data based at least in part on the determined non-compliance,
a non-compliance log indicative of the non-compliance data, and
one or more calculated datasets indicative of calculations performed in the analysis of the simulation output; and
execute a second machine learning model, comprising a deep learning model having persistent memory, to:
adjust one or more settings of the electrical power generator model or electrical system model based at least in part on the non-compliance and a previously learned result, and
cause one or more simulators to perform a second set of one or more simulations of the electrical power generator model or electrical system model with the adjusted settings.

2. The system of claim 1, wherein the instruction file comprises a plain text file that includes parameters for the first set of one or more simulations, the analysis of the simulation output, or any combination thereof.

3. The system of claim 1, wherein the one or more computers are further configured to utilize a scheduler and allocation module configured to:
cause the one or more simulators to perform the first set of one or more simulations; and
cause the one or more simulators to perform the second set of one or more simulations with the adjusted settings requested from the second machine learning model.

4. The system of claim 1, wherein the one or more computers are further configured to:
perform one or more iterations of compliance analysis checks based at least in part on the first machine learning model; and
generate the one or more augmented data files based at least in part on the one or more iterations of compliance analysis checks.

5. (canceled)

6. (canceled)

7. (canceled)

8. The system of claim 1, wherein the one or more computers are configured to establish an order of model simulation based at least in part on a priority associated with the electrical power generator model or electrical system model.

9. (canceled)

10. The system of claim 1, wherein the first set of one or more simulations comprises at least two simulations or simulation programs, and wherein the one or more computers are further configured to generate a graph with results from the at least two simulations or simulation programs.

11. The system of claim 1, wherein the one or more computers are configured to output a compliance report based at least in part on the compliance output and in accordance with the instruction file, wherein the compliance report comprises at least a portion of:
a California ISO (CAISO) generator grid connection study report,
a New York ISO (NYISO) generator grid connection study report,
an Electric Reliability Council of Texas (ERCOT) generator grid connection study report,
a Midcontinent Independent System Operator (MISO) generator grid connection study report,
a New England Independent System Operator (NE-ISO) generator grid connection study report,
a Southwest Power Pool (SPP) generator grid connection study report,
a Pennsylvania-New Jersey-Maryland Interconnection (PJM) generator grid connection study report,
an Alberta Electric System Operator (AESO) generator grid connection study report,
an Independent Electricity System Operator (IESO) generator grid connection study report,
an Australian Energy Market Operator (AEMO) generator grid connection study report,
a Model Acceptance Test (MAT) report,
a Model Quality Test (MQT) report,
a Dynamic Model Acceptance Tests (DMAT) report,
a Generator Performance Standard (GPS) report,
a Distributed Generator System Impact study report,
a Distributed Generator PQ Capability report, or
any combination thereof.

12. The system of claim 11, wherein the one or more computers are configured to include, in the compliance report, a digital fingerprint created by a third party system or web application.

13. The system of claim 11, wherein the one or more computers are configured to include, in the compliance report, a verified report comprising a verified version of the compliance report, the verified report further comprising a HASH or other unique identifier associated with input information provided to the system or a project associated with the input information.

14. The system of claim 13, wherein the verified report comprises the HASH, the one or more computers are further configured to generate the HASH.

15. (canceled)

16. The system of claim 11, wherein the one or more computers are configured to include, in the compliance report, a verified version of the compliance report in a verified package, the verified package further comprising the generator model input information and a HASH or other unique identifier associated with the generator model input information.

17. The system of claim 16, wherein the one or more computers are configured to include, in the verified package, the HASH, and wherein the one or more computers are configured to generate the HASH.

18. The system of claim 16, wherein the one or more computers are configured to include, in the verified package, a link to a web page comprising:
the HASH or other unique identifier,
names of all files in the verified package,
times the files of the generator model input information were received by one or more computers, or
any combination thereof.

19. The system of claim 1, wherein the one or more computers are configured to store:
the instruction file including instructions for simulating and reporting a grid connection model,
one or more power system description files including a description of how components of an electrical power generator model or electrical system model are connected,
one or more component files including a description of behavior of a component of the electrical power generator model or electrical system model,
the one or more tabulated data files,
data file compliance requirements indicative of compliance requirements for each of the one or more tabulated data files,
the one or more augmented data files,
the non-compliance log,
the one or more calculated datasets,
a compliance report,
one or more flags associated with the first set of one or more simulations, or
any combination thereof.

20. A method, performed by one or more computers, of generating a compliance output for distributed electrical power generators, the method comprising:
obtaining a simulation output of a first set of one or more simulations of an electrical power generator model or electrical system model, the simulation output comprising:
one or more tabulated data files of simulation data, and
data file compliance requirements indicative of dynamic performance requirements for each of the one or more tabulated data files to meet to comply with grid codes of a jurisdiction of compliance;
determining, with a first machine learning model, a non-compliance within the simulation output_based at least in part on an analysis of the simulation output and in accordance with an instruction file, the non-compliance comprising a failure of at least one tabulated data file of the one or more tabulated data files to meet the compliance requirements;
generating the compliance output, wherein the compliance output comprises:
one or more augmented data files, the one or more augmented data files comprising the one or more tabulated data files and corresponding non-compliance data based at least in part on the determined non-compliance,
a non-compliance log indicative of the non-compliance data, and
one or more calculated datasets indicative of calculations performed in the analysis of the simulation output; and
executing a second machine learning model, comprising a deep learning model having persistent memory, to:
adjust one or more settings of the electrical power generator model or electrical system model based at least in part on the non-compliance and a previously learned result, and
cause one or more simulators to perform a second set of one or more simulations of the electrical power generator model or electrical system model with the adjusted settings.

21. The system of claim 1, wherein the dynamic performance requirements include requirements for rise times, settling times, overvoltage duration, overvoltage magnitude, bounce height, oscillation magnitude, oscillation decay rate, oscillation start time, oscillation end time, oscillation duration, frequency of oscillation, fast jumps, deleterious behaviors, bounces, power relative to frequency, diQdv curve, or any combination thereof.

22. The system of claim 1, wherein, to determine the non-compliance within the simulation output, the first machine learning model is configured to:
scan the simulation output to lock onto an oscillation within a predetermined frequency range;
select a window of data within the simulation output; and
execute a frequency sweeping phase locked loop to determine frequencies and decay rates within the window data.

23. The system of claim 1, wherein the second machine learning model is configured to cause the one or more simulators to perform the second set of one or more simulations prior to completion of compliance checks of the simulation output by the first machine learning model.

24. The system of claim 1, wherein simulation output comprises data at timesteps of 10 microseconds to 500 microseconds for each of a plurality of simulated signals.

25. The system of claim 24, wherein, to adjust one or more settings of the electrical power generator model or electrical system model, the deep learning AI model is configured to adjust an inverter setting, a power plant controller setting, or both.
